(19) United States
(12) Patent Application Publication
(10) Pub. No.: US 2026/0236076 A1
(43) Pub. Date: Aug. 13, 2026

(54) Ramp-up and ramp-down current control in reconfigurable processors

(71) Applicant: SambaNova Systems, Inc., Palo Alto, CA (US)

(72) Inventors: Junwei ZHOU, Sunnyvale, CA (US); Jinuk SHIN, San Jose, CA (US); Youngmoon CHOI, Milpitas, CA (US); Darshan Gandhi, Palo Alto, CA (US)

(73) Assignee: SambaNova Systems, Inc., Palo Alto, CA (US)

(21) Appl. No.: 19/051,776

(22) Filed: Feb. 12, 2025

(51) Int. Cl. G06F 1/26

(52) U.S. Cl. CPC G06F 1/26

(57) ABSTRACT

A reconfigurable processor integrated circuit (IC) has multiple power base units (PBUs) arranged in an array of rows and columns with dedicated wiring that couples neighboring PBUs. A PBU includes a compute unit, a power estimator (PE) configured to determine an estimated nominal dynamic power dissipated by the compute unit in the PBU, a local power accumulator, and a local control circuit coupled to the local power accumulator. The local power accumulator adds the estimated nominal dynamic power to an accumulated nominal dynamic power received from a neighboring PBU via the dedicated wiring to determine a local nominal dynamic power estimate. The local control circuit is configured to generate a control signal and initiate a predetermined countermeasure that affects a ramp-up or a ramp-down current in the PBU upon determining that the local nominal dynamic power estimate exceeds a first threshold or is below a second threshold.

### REFERENCES

The following are incorporated by reference for all purposes:
Prabhakar et al., “Plasticine: A Reconfigurable Architecture for Parallel Patterns,” ISCA '17, June 24-28, 2017, Toronto, ON, Canada;
Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018; and
U.S. Non-provisional patent application Ser. No. 18/089,891, now U.S. Pat. No. 12,072,748 B2, filed Dec. 28, 2022, entitled, “HIGH-BANDWIDTH POWER ESTIMATOR FOR AI ACCELERATOR”.

Each publication, patent, and/or patent application mentioned in this specification is herein incorporated by reference in its entirety to the same extent as if each individual publication and/or patent application was specifically and individually indicated to be incorporated by reference.

### BACKGROUND

### Technical Field

The disclosed implementations relate generally to performance and power optimization in reconfigurable processor integrated circuits (ICs). In particular, it relates to estimating and predicting power in machine learning (ML) and artificial intelligence (AI) processor chips and initiating proactive power management operations therein.

### Context

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Increasing performance in reconfigurable processor ICs for ML/AI brings significant challenges for thermal and electrical design of a full stack-hardware design that includes both the chip and the system in which the chip is used. Until now, on-chip power management has been reactive. Traditional designs depend on thermal sensor and/or current sensor readings, which take in the order of milliseconds to measure and respond. During this time, a system can become unreliable, unless it has relatively large margin, reducing its performance.

### BRIEF DESCRIPTION OF THE DRAWINGS

The technology will be described with reference to the drawings, in which:

FIG. 1 illustrates an example system including a coarse-grained reconfigurable (CGR) processor, a host, and a memory.

FIG. 2 illustrates an example of a computer, including an input device, a processor, a storage device, and an output device.

FIG. 3 illustrates example details of a CGR architecture including a top-level network (TLN) and two CGR arrays.

FIG. 4 illustrates an example CGR array, including an array of CGR units in an array-level network (ALN).

FIG. 5 illustrates an example of a pattern memory unit (PMU) and a pattern compute unit (PCU), which may be combined in a fused-control memory unit (FCMU).

FIG. 6 illustrates an example architecture with a distributed power information and control network.

FIG. 7 illustrates an example power base unit (PBU).

FIG. 8 illustrates details of a power base unit implementation with a power estimator (PE) and a local control circuit (LCC).

FIG. 9 illustrates details of an example PE for nominal dynamic power estimation in a PCU.

FIG. 10 illustrates an example finite state machine (FSM) for controlling the ramp-up and ramp-down current in a PBU.

FIG. 11 illustrates details of an example column power accumulator (CPA).

FIG. 12 illustrates details of an example global power accumulator (GPA) that determines the array-level nominal dynamic power estimate and that is coupled to a global control circuit (GCC).

FIG. 13 illustrates details of an example power clock management controller (PCMC) that determines the global static power estimate and the global total power estimate.

FIG. 14 illustrates an example method of estimating local power dissipation in an array of compute units and the initiation of counter measures to control the ramp-up and/or ramp-down current in the array of compute units.

In the figures, like reference numbers may indicate functionally similar elements. The systems and methods illustrated in the figures, and described in the Detailed Description below, may be arranged and designed in a wide variety of different implementations. Neither the figures nor the Detailed Description are intended to limit the scope as claimed. Instead, they merely represent examples of different implementations.

### DETAILED DESCRIPTION

Deep learning is a subset of machine learning algorithms that are inspired by the structure and function of the human brain. Most deep learning algorithms involve artificial neural network architectures, in which multiple layers of neurons each receive input from neurons in a prior layer or layers, and in turn influence the neurons in the subsequent layer or layers. Training these neural network models can be computationally extremely demanding.

As machine learning based technologies are more widely deployed, it is becoming important to implement them at low cost using flexible hardware architectures. In such architectures, including integrated circuit components, area, and power consumption are critical design parameters. One class of integrated circuits includes reconfigurable processor integrated circuits, which are sometimes also simply referred to as reconfigurable processors.

Reconfigurable processors can be configured to implement a variety of functions. In particular, so-called Coarse-Grained Reconfigurable Architectures (CGRAs) are being developed in which the configurable units in the array are complex and that may enable faster or more efficient execution of various classes of functions. For example, CGRAs have been proposed that can enable implementation of energy-efficient accelerators for machine learning and artificial intelligence workloads. See, Prabhakar, et al., “Plasticine: A Reconfigurable Architecture for Parallel Patterns,” ISCA '17, Jun. 24-28, 2017, Toronto, ON, Canada. Various aspects of some of such CGRAs are described in the above-incorporated patent applications.

A CGRA typically includes an array of reconfigurable units and operate on streams of data and control messages that flow through a sea of these reconfigurable units, sometimes referred to herein as Coarse-Grained Reconfigurable Units (CGRUs). The units can comprise somewhat specialized computational and memory units.

The heart of deep learning is matrix multiplication. Thus, matrix multiplication is used in many applications for machine learning and artificial intelligence. Furthermore, matrix multiplication forms the basis for many computations in linear algebra because it is the core routine behind the Level-3 basic linear algebra subprograms (BLAS) and much of linear algebra package (LAPACK).

Matrix multiplication operations typically require architectures that are adapted for parallel processing. Systolic arrays are an extremely attractive platform for performing matrix multiplication when performance, power, or energy efficiency are paramount. A systolic array has a parallel architecture, made out of relatively simple processors, that are regularly and locally connected. The data circulate through these processors in a synchronous manner and interact where they meet.

Coarse-grained reconfigurable architectures (CGRAs) may be configured to implement a systolic array for matrix multiplication. However, in such implementations, many compute units of a CGR processor circuit, which is sometimes simply referred to as a CGR processor, operate in lock step, causing these compute units to start the same operations in small delta cycles and also to stop these operations in small delta cycles leading to a sudden draw or drop in current in a delta time.

This sudden draw or drop in current often causes large positive changes in current (i.e., large positive di/dt) or large negative changes in current (i.e., large negative di/td). The positive changes in current are sometimes also referred to as ramp-up current, and the negative changes in current are sometimes referred to as ramp-down current. Large ramp-up currents or large ramp-down currents often cause an undershoot in supply voltage or an overshoot in supply voltage that can lead to a shutdown of the CGR processor circuit. Therefore, it is desirable to slow down the positive and negative current changes such that the ramp-up and ramp-down occur over a longer period of time (i.e., a decrease in di/dt).

The technology disclosed herein provides such systems and methods, monitoring activity of compute units in a CGR processor circuit and reacting to large ramp-up and large ramp-down current events quickly to reduce the slopes of the ramp-up currents and ramp-down currents.

An integrated circuit may include an array of compute units, each paired with a memory unit, and a switch to connect the compute units and the memory units with an array-level network. The compute units, memory units, and switches may operate from substantially the same supply voltage, and from the same clock, or from clocks operating at clock frequencies that are in a fixed proportion to each other. The die temperature may be substantially constant over the die (although not necessarily over time) due to the high thermal conductivity of silicon. The clock frequency and supply voltage may be controlled by a dynamic frequency and voltage scaling controller to operate the chip within electrical and thermal limits of the system. When the array's performance must be maximized, the clock frequency must be as high as the supply voltage permits. When the array's power must be minimized, the voltage must be as low as the clock frequency permits for sufficient performance.

Conventional analog measurement and processing of power spikes caused by large ramp-up currents and large ramp-down currents can be too slow, or may not have sufficient bandwidth, or may underestimate the locality of such ramp-up or ramp-down currents, while countermeasures that address these large current changes may not be available.

The disclosed technology resolves this by pairing each compute unit with a power estimator (PE), a local power accumulator (LPA), and a local control circuit (LCC). The resulting combination of a switch, a memory unit, a compute unit, a PE, an LPA, and an LCC is called a power base unit (PBU). The PE estimates the nominal dynamic power usage for at least the compute unit, based on a nominal clock frequency and a nominal supply voltage.

The array level network connects an array of PBUs. Each PBU digitally communicates, via dedicated wiring, which is sometimes also referred to as a local power information network, its total estimated nominal dynamic power usage to a neighboring PBU. The LPA adds the estimated nominal dynamic power usage from the PE with estimated nominal dynamic power usage from neighboring PBUs. The LCC that is coupled to the LPA is configured to generate control signals and initiate counter measurements that affect the ramp-up and/or the ramp-down current in the PBU and the neighboring PBUs.

If desired, each PBU digitally communicates, via other dedicated wiring, which is sometimes also referred to as an array-level power information network or simply a power information network, its total estimated nominal dynamic power usage to an array-level power accumulator, which is sometimes also referred to as a global power accumulator (GPA). The use of dedicated wiring for the power information network means that wires can be used very efficiently, and that the speed (bandwidth) of the power information network can be very high. Implementations add timestamps to estimates to achieve maximum granularity and accuracy of the estimates. The GPA may filter the received power estimates, for example in a mean average and a moving average, and determine the array-level estimated nominal dynamic power usage. An array-level control circuit, which is sometimes also referred to as a global control circuit (GCC), is coupled to the GPA and configured to generate control signals that initiate counter measurements that affect the ramp-up and/or the ramp-down current in the PBUs globally based on the estimated global dynamic power dissipation. The GCC is configured to transmit the control signals via additional dedicated wiring, which is sometimes also referred to as an array-level power control network or simply a power control network to the PBUs in the array of PBUs. The power information network and the power control network are hereinafter collectively also referred to as power information and control network.

A power clock management controller (PCMC) receives the array-level estimated nominal dynamic power from the GPA, and scales it with frequency and voltage scale factors that are based on the actual clock frequency and measured supply voltage to obtain an estimated actual dynamic power. It also estimates static power (leakage) for the array based on the measured supply voltage and the die temperature. The PCMC adds the dynamic power and static power estimates to obtain a total estimated power.

### Terminology

As used herein, the phrase “one of” should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The terms “comprising” and “consisting” have different meanings in this patent document. An apparatus, method, or product “comprising” (or “including”) certain features means that it includes those features but does not exclude the presence of other features. On the other hand, if the apparatus, method, or product “consists of” certain features, the presence of any additional features is excluded.

The term “coupled” is used in an operational sense and is not limited to a direct or an indirect coupling. “Coupled” in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term “connected” is used to indicate a direct connection, such as electrical, optical, electromagnetic, or mechanical, between the things that are connected, without any intervening things or devices.

The term “configured” to perform a task or tasks is a broad recitation of structure generally meaning having circuitry that performs the task or tasks during operation. As such, the described item can be configured to perform the task even when the unit/circuit/component is not currently on or active. In general, the circuitry that forms the structure corresponding to configured to may include hardware circuits, and may further be controlled by switches, fuses, bond wires, metal masks, firmware, and/or software. Similarly, various items may be described as performing a task or tasks, for convenience in the description. Such descriptions should be interpreted as including the phrase configured to.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B”. This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase based on is thus synonymous with the phrase based at least in part on.

The terms “substantially”, “close”, “approximately”, “near”, and “about” refer to being within minus or plus 10% of an indicated value, unless explicitly specified otherwise.

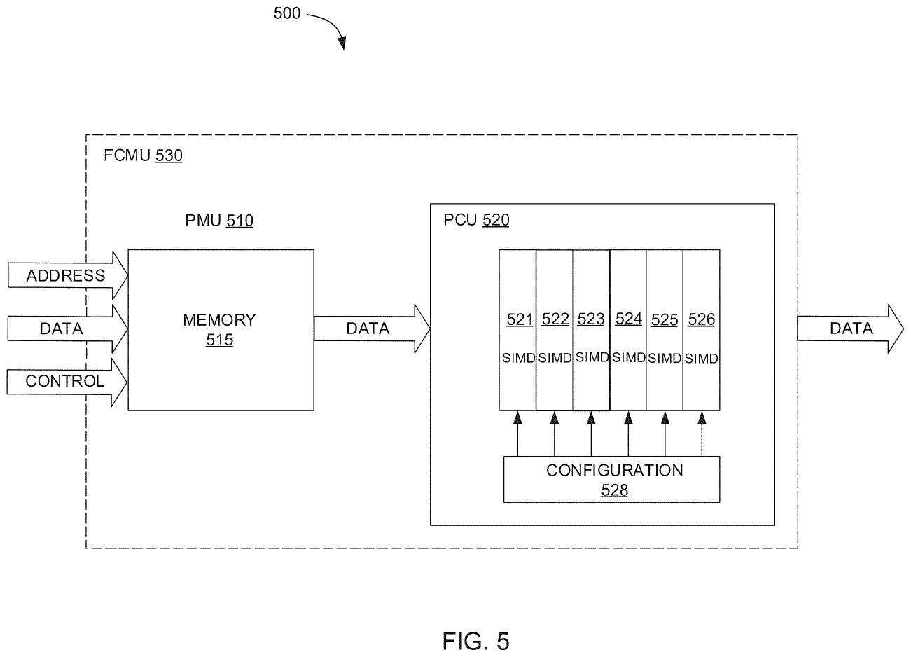

The following terms or acronyms used herein are defined at least in part as follows:
AGCU—address generator (AG) and coalescing unit (CU).
AI—artificial intelligence.
AIR—arithmetic or algebraic intermediate representation.
ALN—array-level network.
Buffer—an intermediate storage of data.
CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.
CGRA—coarse-grained reconfigurable architecture. A data processor architecture that includes one or more arrays (CGR arrays) of CGR units.
CGR Array—an array of CGR units, coupled with each other through an array-level network (ALN), and coupled with external elements via a top-level network (TLN). A CGR array can physically implement the nodes and edges of a dataflow graph.
CGR unit—a circuit that can be configured and reconfigured to locally store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.
CPA—column power accumulator.
Compiler—a translator that processes statements written in a programming language to machine language instructions for a computer processor. A compiler may include multiple stages to operate in multiple steps. Each stage may create or update an intermediate representation (IR) of the translated statements. Compiler stages are illustrated with reference to FIG. 5.
Computation graph—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.
CU—coalescing unit.
Data Flow Graph—a computation graph that includes one or more loops that may be nested, and wherein nodes can send messages to nodes in earlier layers to control the dataflow between the layers.
Datapath—a collection of functional units that perform data processing operations. The functional units may include memory, multiplexers, ALUs, SIMDs, multipliers, registers, buses, etc.
FCMU—fused compute and memory unit—a circuit that includes both a memory unit and a compute unit.
FSM—finite state machine.
GCC—global control circuit.
GPA—global power accumulator.
Graph—a collection of nodes connected by edges. Nodes may represent various kinds of items or operations, dependent on the type of graph. Edges may represent relationships, directions, dependencies, etc.
IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
LCC—local control circuit.
LPA—local power accumulator.
LUT—lookup table.
ML—machine learning.
PBU—power base unit—a combination of a switch, a memory unit, and a compute unit including one or more power estimators.
PCMC—power clock management controller.
PCU—pattern compute unit—a compute unit that can be configured to repetitively perform a sequence of operations.
PE—Power estimator.
PICN—Power information and control network.
Pipeline—a staggered flow of operations through a chain of pipeline stages. The operations may be executed in parallel and in a time-sliced fashion. Pipelining increases overall instruction throughput. CGR processors may include pipelines at different levels. For example, a compute unit may include a pipeline at the gate level to enable correct timing of gate-level operations in a synchronous logic implementation of the compute unit, and a meta-pipeline at the graph execution level (typically a sequence of logical operations that are to be repetitively executed) that enables correct timing and loop control of node-level operations of the configured graph. Gate-level pipelines are usually hard wired and unchangeable, whereas meta-pipelines are configured at the CGR processor, CGR array level, and/or GCR unit level.
Pipeline Stages—a pipeline is divided into stages that are coupled with one another to form a pipe topology.
PMU—pattern memory unit—a memory unit that can locally store data according to a programmed pattern.
SIMD—single-instruction multiple-data—an arithmetic logic unit (ALU) that simultaneously performs a single programmable operation on multiple data elements delivering multiple output results.
TLN—top-level network.

### Implementations

The architecture, configurability and dataflow capabilities of an array of CGR units enable increased compute power that supports both parallel and pipelined computation. A CGR processor, which includes one or more CGR arrays (arrays of CGR units), can be programmed to simultaneously execute multiple independent and interdependent dataflow graphs. To enable simultaneous execution, the dataflow graphs may need to be distilled from a high-level program and translated to a configuration file for the CGR processor. A high-level program is source code written in programming languages like Spatial, Python, C++, and C, and may use computation libraries for scientific computing, ML, AI, and the like. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL.

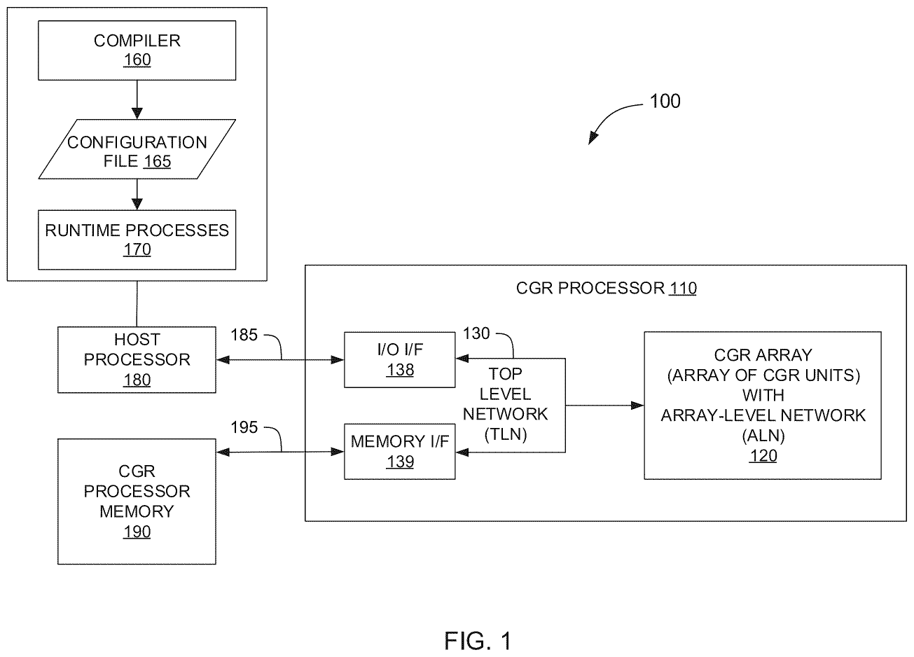

FIG. 1 illustrates an example system 100 including a CGR processor 110, a host 180, and a memory 190. CGR processor 110 has a coarse-grained reconfigurable architecture (CGRA) and includes an array of CGR units 120 such as a CGR array. CGR processor 110 further includes an IO interface 138, and a memory interface 139. Array of CGR units 120 is coupled with IO interface 138 and memory interface 139 via databus 130 which may be part of a top-level network (TLN). Host 180 communicates with IO interface 138 via system databus 185, and memory interface 139 communicates with memory 190 via memory bus 195. Array of CGR units 120 may further include compute units and memory units that are connected with an array-level network (ALN) to provide the circuitry for execution of a computation graph or a dataflow graph that may have been derived from a high-level program with user algorithms and functions. The high-level program may include a set of procedures, such as learning or inferencing in an AI or ML system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. In some implementations, execution of the graph(s) may involve using multiple units of CGR processor 110. In some implementations, CGR processor 110 may include one or more ICs. In other implementations, a single IC may span multiple CGR processors. In further implementations, CGR processor 110 may include one or more units of array of CGR units 120.

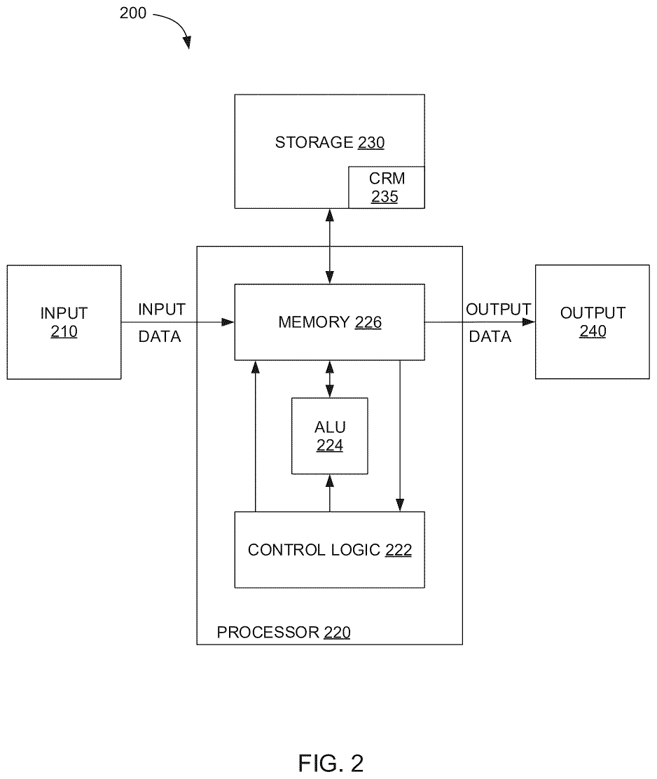

Host 180 may be, or include, a computer such as further described with reference to FIG. 2. Host 180 runs runtime processes, as further referenced herein, and may also be used to run computer programs, such as the compiler 160. In some implementations, the compiler 160 may run on a computer that is similar to the computer described with reference to FIG. 2, but separate from host 180.

CGR processor 110 may accomplish computational tasks by executing a configuration file 165. For the purposes of this description, a configuration file corresponds to a dataflow graph, or a translation of a dataflow graph, and may further include initialization data. A compiler 160 compiles the high-level program to provide the configuration file 165. Runtime processes 170 may install the configuration file 165 in CGR processor 110. In some implementations described herein, a CGR array 120 is configured by programming one or more configuration stores with all or parts of the configuration file 165. A single configuration store may be at the level of the CGR processor 110 or the CGR array 120, or a CGR unit may include an individual configuration store. The configuration file 165 may include configuration data for the CGR array 120 and CGR units in the CGR array 120, and link the computation graph to the CGR array 120. Execution of the configuration file by CGR processor 110 causes the CGR array 120 to implement the user algorithms and functions in the dataflow graph.

CGR processor 110 can be implemented on a single integrated circuit (IC) die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

FIG. 2 illustrates an example of a computer 200, including an input device 210, a processor 220, a storage device 230, and an output device 240. Although the example computer 200 is drawn with a single processor, other implementations may have multiple processors. Input device 210 may comprise a mouse, a keyboard, a sensor, an input port (for example, a universal serial bus (USB) port), and any other input device known in the art. Output device 240 may comprise a monitor, printer, and any other output device known in the art. Furthermore, part or all of input device 210 and output device 240 may be combined in a network interface, such as a Peripheral Component Interconnect Express (PCIe) interface suitable for communicating with CGR processor 110. Input device 210 is coupled with processor 220 to provide input data, which an implementation may store in memory 226. Processor 220 is coupled with output device 240 to provide output data from memory 226 to output device 240. Processor 220 further includes control logic 222, operable to control memory 226 and arithmetic and logic unit (ALU) 224, and to receive program and configuration data from memory 226. Control logic 222 further controls exchange of data between memory 226 and storage device 230. Memory 226 typically comprises memory with fast access, such as static random-access memory (SRAM), whereas storage device 230 typically comprises memory with slow access, such as dynamic random-access memory (DRAM), flash memory, magnetic disks, optical disks, and any other memory type known in the art. At least a part of the memory in storage device 230 includes a non-transitory computer-readable medium (CRM 235), such as used for storing computer programs.

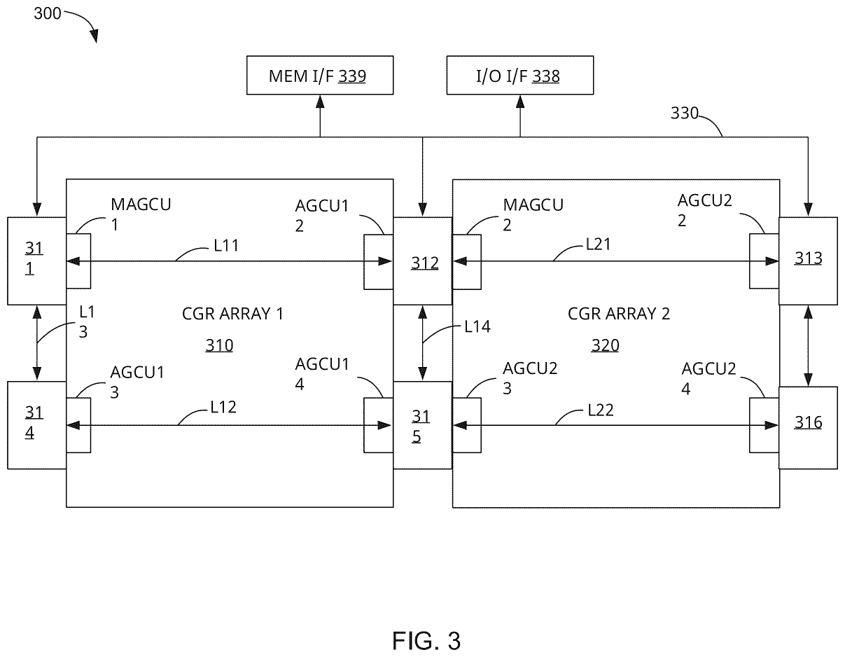

FIG. 3 illustrates example details of a CGR architecture 300 including a top-level network (TLN 330) and two CGR arrays (CGR array 310 and CGR array 320). A CGR array comprises an array of CGR units (e.g., PMUs, PCUs, FCMUs) coupled via an array-level network (ALN), e.g., a bus system. The ALN is coupled with the TLN 330 through several AGCUs, and consequently with I/O interface 338 (or any number of interfaces) and memory interface 339. Other implementations may use different bus or communication architectures.

Circuits on the TLN in this example include one or more external I/O interfaces, including I/O interface 338 and memory interface 339. The interfaces to external devices include circuits for routing data among circuits coupled with the TLN and external devices, such as high-capacity memory, host processors, other CGR processors, FPGA devices, and so on, that are coupled with the interfaces.

Each depicted CGR array has four AGCUs (e.g., a master AGCU (MAGCU) labeled MAGCU1, and three other AGCUs labeled AGCU12, AGCU13, and AGCU14 in CGR array 310). The AGCUs interface the TLN to the ALNs and route data from the TLN to the ALN or vice versa. Other implementations may have different numbers of AGCUs.

One of the AGCUs in each CGR array in this example is configured to be a master AGCU (MAGCU), which includes an array configuration load/unload controller for the CGR array. The MAGCU1 includes a configuration load/unload controller for CGR array 310, and MAGCU2 includes a configuration load/unload controller for CGR array 320. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

The TLN is constructed using top-level switches (switch 311, switch 312, switch 313, switch 314, switch 315, and switch 316) coupled with each other as well as with other circuits on the TLN, including the AGCUs, external I/O interface 338, and external memory interface 339. The TLN includes links (e.g., L11, L12, L21, L22) coupling the top-level switches. Data may travel in packets between the top-level switches on the links, and from the switches to the circuits on the network coupled with the switches. For example, switch 311 and switch 312 are coupled by link L11, switch 314 and switch 315 are coupled by link L12, switch 311 and switch 314 are coupled by link L13, and switch 312 and switch 313 are coupled by link L21. The links can include one or more buses and supporting control lines, including for example a chunk-wide bus (vector bus). For example, the top-level network can include data, request and response channels operable in coordination for transfer of data in any manner known in the art.

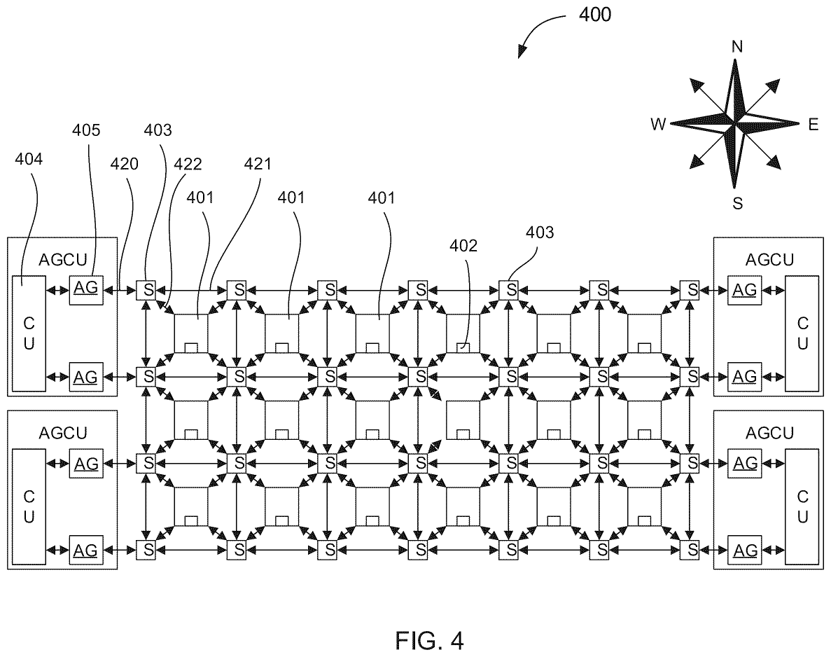

FIG. 4 illustrates an example CGR array 400, including an array of CGR units in an ALN. CGR array 400 may include several types of CGR unit 401, such as FCMUs, PMUs, PCUs, memory units, and/or compute units. For examples of the functions of these types of CGR units, see Prabhakar et al., “Plasticine: A Reconfigurable Architecture for Parallel Patterns”, ISCA 2017, Jun. 24-28, 2017, Toronto, ON, Canada. Each of the CGR units may include a configuration store 402 comprising a set of registers or flip-flops storing configuration data that represents the setup and/or the sequence to run a program, and that can include the number of nested loops, the limits of each loop iterator, the instructions to be executed for each stage, the source of operands, and the network parameters for the input and output interfaces. In some implementations, each CGR unit 401 comprises an FCMU. In other implementations, the array comprises both PMUs and PCUs, or memory units and compute units, arranged in a checkerboard pattern. In yet other implementations, CGR units may be arranged in different patterns. The ALN includes switch units 403 (S), and AGCUs (each including two address generators 405 (AG) and a shared coalescing unit 404 (CU)). Switch units 403 are connected among themselves via interconnects 421 and to a CGR unit 401 with interconnects 422. Switch units 403 may be coupled with address generators 405 via interconnects 420. In some implementations, communication channels can be configured as end-to-end connections, and switch units 403 are CGR units. In other implementations, switches route data via the available links based on address information in packet headers, and communication channels establish as and when needed.

A configuration file may include configuration data representing an initial configuration, or starting state, of each of the CGR units that execute a high-level program with user algorithms and functions. Program load is the process of setting up the configuration stores in the CGR array based on the configuration data to allow the CGR units to execute the high-level program. Program load may also require loading memory units and/or PMUs.

The ALN includes one or more kinds of physical data buses, for example a chunk-level vector bus (e.g., 512 bits of data), a word-level scalar bus (e.g., 32 bits of data), and a control bus. For instance, interconnects 421 between two switches may include a vector bus interconnect with a bus width of 512 bits, and a scalar bus interconnect with a bus width of 32 bits. A control bus can comprise a configurable interconnect that carries multiple control bits on signal routes designated by configuration bits in the CGR array's configuration file. The control bus can comprise physical lines separate from the data buses in some implementations. In other implementations, the control bus can be implemented using the same physical lines with a separate protocol or in a time-sharing procedure.

Physical data buses may differ in the granularity of data being transferred. In one implementation, a vector bus can carry a chunk that includes 16 channels of 32-bit floating-point data or 32 channels of 16-bit floating-point data (i.e., 512 bits) of data as its payload. A scalar bus can have a 32-bit payload and carry scalar operands or control information. The control bus can carry control handshakes such as tokens and other signals. The vector and scalar buses can be packet-switched, including headers that indicate a destination of each packet and other information such as sequence numbers that can be used to reassemble a file when the packets are received out of order. Each packet header can contain a destination identifier that identifies the geographical coordinates of the destination switch unit (e.g., the row and column in the array), and an interface identifier that identifies the interface on the destination switch (e.g., North, South, East, West, etc.) used to reach the destination unit.

As shown in FIG. 4, a CGR unit 401 may have four ports to interface with switch units 403, or any other number of ports suitable for an ALN. Each port may be suitable for receiving and transmitting data, or a port may be suitable for only receiving or only transmitting data.

A switch unit 403, as shown in the example of FIG. 4, may have eight interfaces. The North, South, East and West interfaces of a switch unit 403 may be used for links between switch units using interconnects 421. The Northeast, Southeast, Northwest and Southwest interfaces of a switch unit 403 may each be used to make a link with an FCMU, PCU or PMU instance using one of the interconnects 422. Two switch units 403 in each CGR array quadrant have links to an AGCU using interconnects 420. The AGCU coalescing unit 404 arbitrates between the AGs 405 and processes memory requests. Each of the eight interfaces of a switch unit 403 can include a vector interface, a scalar interface, and a control interface to communicate with the vector network, the scalar network, and the control network. In other implementations, a switch unit 403 may have any number of interfaces.

During execution of a graph or subgraph in a CGR array after configuration, data can be sent via one or more switch units 403 and one or more links between the switch units 403 to the CGR units 401 using the vector bus and vector interface(s) of the one or more switch units on the ALN. A CGR array may comprise at least a part of CGR array 400, and any number of other CGR arrays coupled with CGR array 400.

A data processing operation implemented by CGR array configuration may comprise multiple graphs or subgraphs specifying data processing operations that are distributed among and executed by corresponding CGR units (e.g., FCMUs, PMUs, PCUs) as well as AGs, and CUs.

FIG. 5 illustrates an example 500 of a PMU 510 and a PCU 520, which may be combined in an FCMU 530. PMU 510 may be directly coupled to PCU 520, or optionally via one or more switches. PMU 510 includes a scratchpad memory 515, which may receive external data, memory addresses, and memory control information (e.g., write enable, read enable, etc.) via one or more buses included in the ALN. PCU 520 includes two or more processor stages, such as SIMD 521 through SIMD 526, and configuration store 528. The processor stages may include ALUs, or SIMDs, as drawn, or any other reconfigurable data processing stages.

Each stage in PCU 520 may also hold one or more registers (not shown) for short-term storage of parameters. Short-term storage, for example during one to several clock cycles or unit delays, allows for synchronization of data in the PCU pipeline.

### Ramp-Up and Ramp-Down Current Control

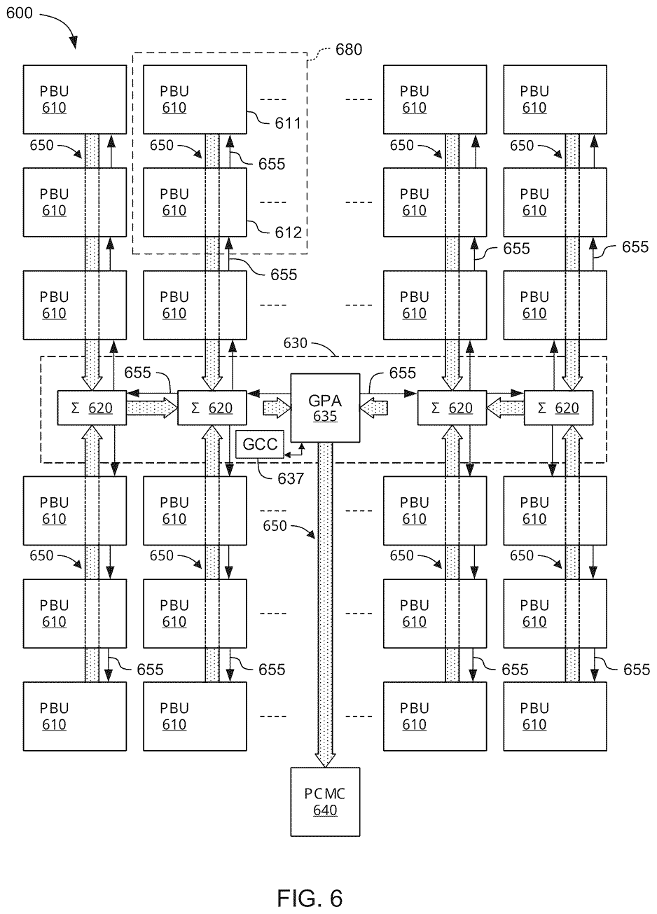

FIG. 6 illustrates an example architecture 600 with a distributed power information and control network. Architecture 600 includes an array of power base units (PBUs), each comprising a combination of a switch and an FCMU or a combination of a switch, a memory unit (such as a PMU) and a compute unit (such as a PCU). The array is similar to the arrays shown in FIGS. 3-4. The array includes a power information network 650 (or databus or other dedicated wiring to transfer power information), a power control network 655 (or databus or other dedicated wiring to transfer ramp-up and ramp-down current control information) and may additionally include an ALN (not shown in FIG. 6).

Each PBU 610 estimates the nominal dynamic power usage for at least the compute unit in the respective PBU 610 based on a nominal clock frequency and a nominal supply voltage. Each PBU 610 digitally communicates its total estimated nominal dynamic power usage to a local power accumulator (LPA) within the PBU 610 and from there, via the power information network 650 to an array-level power accumulator 630, for example including a global power accumulator (GPA 635) and additional power accumulators, such as column power accumulators (CPAs 620) or row power accumulators (RPAs).

Illustratively, each PBU 610 conveys nominal dynamic power data to other PBUs in the same column. A column power accumulator (CPA) may be configured to determine a column total estimated dynamic power dissipation in a column of PBUs, and to transmit the column total estimated dynamic power dissipation in the column of PBUs to the global power accumulator 635 via the dedicated wiring of the power information network 650. In some implementations, each PBU 610 of a column conveys the nominal dynamic power data directly to the CPAs which accumulates all the data of a column. In other implementations, the power information network 650 is organized in a daisy chain and each PBU 610 adds its own power number to the power number from preceding PBUs in the column before passing the result on to the next PBU in the column or to the CPA, which adds the power numbers from the column above, the power numbers from the column below, and the power numbers from preceding CPAs together.

If desired, each PBU conveys nominal dynamic power data to other PBUs in the same row. A row power accumulator (RPA) may be configured to determine a row total estimated dynamic power dissipation in a row of PBUs, and to transmit the row total estimated dynamic power dissipation in the row of PBUs to the global power accumulator via the dedicated wiring of the power information network 650. In some implementations, each PBU of a row conveys the nominal dynamic power data directly to the RPAs which accumulates all the data of a row. In other implementations, the power information network 650 is organized in a daisy chain and each PBU adds its own power number to the power number from preceding PBUs in the row before passing the result on to the next PBU in the row or to the RPA, which adds the power numbers from the row to the left, the power numbers from the row to the right, and the power numbers from preceding RPAs together.

Thus, the dedicated wiring of the power information network 650 transmits the estimated nominal dynamic power from the power estimators (PE) in the multiple PBUs 610 to GPA 635, and GPA 635 may be configured to determine an array-level nominal dynamic power estimate by determining a sum of the estimated nominal dynamic power from the multiple PBUs 610.

An advantage of having a dedicated power information network 650 is its high speed. Because the array-level power accumulator 630 synchronizes all power estimates, it can also provide an excellent estimate of peak power levels and thereby to large ramp-up or ramp-down currents, rather than just averages. This significantly helps preventing timing errors and supply voltage overshoot or undershoot caused by large current changes. For example, a global control circuit (GCC) 637 may be coupled to GPA 635. The GCC 637 may determine whether the array-level nominal dynamic power estimate from the GPA 635 exceeds a first global threshold or whether the array-level nominal dynamic power estimate is below a second global threshold. In response to determining that the array-level nominal dynamic power estimate exceeds the first global threshold, the GCC 637 may generate a first global control signal and transmit the first global control signal via the dedicated wiring of the power control network 655 to the multiple PBUs 610 to initiate a predetermined countermeasure that affects the ramp-up current in the PBUs. In response to determining that the array-level nominal dynamic power estimate is below the second global threshold, the GCC 637 may generate a second global control signal and transmit the second global control signal via the dedicated wiring of the power control network 655 to the multiple PBUs 610 to initiate another predetermined countermeasure that affects the ramp-down current in the PBUs.

If desired, the first and second global thresholds may be selected based on a previously determined global nominal dynamic power estimate. For example, the GCC 637 may store a predetermined number of first and second global thresholds and select one of the first global thresholds and/or one of the second global thresholds based on the global nominal dynamic power estimate determined during a prior time period. If desired, the prior time period may have occurred during an iteration that is temporarily immediately before determining the array-level nominal dynamic power estimate. As an example, consider the scenario in which the GCC 637 stores two different first global thresholds (e.g., a greater first global threshold and a smaller first global threshold) and two different second global thresholds (e.g., a greater second global threshold and a smaller second global threshold). Consider further that the global nominal dynamic power estimate determined during a prior time period corresponds to a number of currently active SIMD stages (e.g., SIMD 521 to 526 of FIG. 5). In this scenario, in response to determining that the number of currently active SIMD stages is smaller than a third threshold, GCC 637 uses the smaller first global threshold for generating the first global control signal (i.e., for ramp-up current control) and the smaller second global threshold for generating the second global control signal (i.e., for ramp-down current control), and in response to determining that the number of currently active SIMD stages is greater than or equal to the third threshold, GCC 637 uses the greater first global threshold for generating the first global control signal (i.e., for ramp-up current control) and the greater second global threshold for generating the second global control signal (i.e., for ramp-down current control), In the current scenario, GCC 637 uses two first global thresholds and two second global thresholds. However, GCC 637 may use any number of first and second global thresholds instead. For example, GCC 637 may use three, four, five, or more first and second global thresholds. GCC 637 may use a same number of first and second global thresholds. If desired, GCC 637 may use a different number of first and second global thresholds. Illustratively, GCC 637 may increase the selected first global threshold with the previously determined global nominal dynamic power estimate, and decrease the second global threshold with the previously determined global nominal dynamic power estimate. For example, in the scenario above, GCC 637 may periodically compute a new first global threshold and a new second global threshold based on the current number of active SIMD stages.

Using more than one first global threshold and more than one second global threshold may prevent the GCC 637 from oscillating between generating a first global control signal for ramp-up current control and generating a second global control signal for ramp-down current control.

In some implementations, configuration data may locally group neighboring PBUs (e.g., a predetermined number of PBUs in the same column or in the same row) together for responses to peak power levels and thereby to large local ramp-up or ramp-down currents. As an example, consider the scenario in which configuration data groups the two PBUs 611, 612 together in a local group 680 for controlling the local ramp-up and ramp-down currents in these two PBUs 611, 612. Note that grouping two PBUs together in a local group for local ramp-up and ramp-down current control is merely illustrative. If desired, any number of PBUs in a column or in a row may be grouped together in such a local group for local ramp-up and ramp-down current control. For example, a single PBU may form such a local group, three PBUs, etc., up to all the PBUs in a column or row.

In this scenario, a power estimator in PBU 611 determines an estimated nominal dynamic power dissipated at least by the compute unit in PBU 611 and transmits the estimated nominal dynamic power to PBU 612 via the dedicated wiring of the power information network 650. Note that in some implementations, the dedicated wiring of the power information network 650 used for transmitting the estimated nominal dynamic power in a local group may use the same dedicated wiring of the power information network 650 that is used for transmitting the estimated nominal dynamic power to the array-level power accumulator 630. In other implementations, the dedicated wiring of the power information network 650 used for transmitting the estimated nominal dynamic power in a local group may use a different dedicated wiring of the power information network 650 that is separate from the dedicated wiring of the power information network 650 used for transmitting the estimated nominal dynamic power to the array-level power accumulator 630.

The power estimator in PBU 612 determines an estimated nominal dynamic power dissipated at least by the compute unit in PBU 612. For example, the power estimator in PBU 612 may determine the estimated nominal dynamic power based on monitoring input data bit toggling, instruction type, and processing activity of one or more reconfigurable data processing stages included in the compute unit of PBU 612.

A local power accumulator (LPA) in PBU 612 adds the estimated nominal dynamic power from PBUs 611 and 612 to determine a local nominal dynamic power estimate. A local control circuit (LCC) in PBU 612 is coupled to the LPA in PBU 612. PBU 612 digitally communicates the local nominal dynamic power estimate from the LPA in PBU 612 to the local control circuit (LCC) in PBU 612. The local control circuit in PBU 612 can be configured to determine whether countermeasures that affect a ramp-up current or a ramp-down current in the PBU are required based on the local nominal dynamic power estimate from the LPA.

In particular, the LCC determines whether the local nominal dynamic power estimate exceeds a first threshold (i.e., the LCC detects a large ramp-up current) or is below a second threshold (i.e., the LCC detects a large ramp-down current). In response to determining that the local nominal dynamic power estimate exceeds the first threshold, the LCC generates a first control signal and initiates a first predetermined countermeasure that affects a ramp-up current in the PBU 612. In response to determining that the local nominal dynamic power estimate is below the second threshold that is smaller than the first threshold, the LCC generates a second control signal and initiates a second predetermined countermeasure that affects a ramp-down current in the PBU 612.

If desired, the first and second thresholds may be selected based on a previously determined local nominal dynamic power estimate. For example, the LCC may store a predetermined number of first and second thresholds and select one of the first thresholds and/or one of the second thresholds based on the local nominal dynamic power estimate determined during a prior time period. If desired, the prior time period may have occurred during an iteration that is temporarily immediately before determining the local nominal dynamic power estimate. As an example, consider the scenario in which the LCC stores two different first thresholds (e.g., a greater first threshold and a smaller first threshold) and two different second thresholds (e.g., a greater second threshold and a smaller second threshold). Consider further that the local nominal dynamic power estimate determined during a prior time period corresponds to a number of currently active SIMD stages (e.g., SIMD 521 to 526 of FIG. 5). In this scenario, in response to determining that the number of currently active SIMD stages is smaller than a third threshold, LCC uses the smaller first threshold for generating the first local control signal (i.e., for ramp-up current control) and the smaller second threshold for generating the second local control signal (i.e., for ramp-down current control), and in response to determining that the number of currently active SIMD stages is greater than or equal to the third threshold, LCC uses the greater first threshold for generating the first local control signal (i.e., for ramp-up current control) and the greater second threshold for generating the second local control signal (i.e., for ramp-down current control), In the current scenario, LCC uses two first thresholds and two second thresholds. However, LCC may use any number of first and second thresholds instead. For example, LCC may use three, four, five, or more first and second thresholds. LCC may use a same number of first and second thresholds. If desired, LCC may use a different number of first and second thresholds. Illustratively, LCC may increase the selected first threshold with the previously determined local nominal dynamic power estimate, and decrease the second threshold with the previously determined local nominal dynamic power estimate. For example, in the scenario above, LCC may periodically compute a new first threshold and a new second threshold based on the current number of active SIMD stages.

Using more than one first threshold and more than one second threshold may prevent the LCC from oscillating between generating a first control signal for ramp-up current control and generating a second control signal for ramp-down current control.

As an example, a first-in first-out (FIFO) buffer may be coupled to the compute unit of PBU 612, and the first predetermined countermeasure may include an insertion of a predetermined number of bubbles into the FIFO. In some implementations, the insertion of a predetermined number of bubbles into the FIFO may include disabling the clock enable on the FIFO for a predetermined number of clock cycles. As another example, the second predetermined countermeasure may include executing a predetermined number of dummy operations in the compute unit of PBU 612. In some implementations, executing a predetermined number of dummy operations in the compute unit may include enabling the clock enable on the FIFO for a predetermined number of clock cycles. If desired, a predetermined operation such as an accumulation operation or a multiply-accumulated operation may be injected into the FIFO in combination with enabling the clock enable on the FIFO.

The LCC of PBU 612 may then transmit the first or second control signal via the dedicated wiring of the power control network 655 to PBU 611. The LCC of PBU 611 receives the first or second signal via the dedicated wiring of the power control network 655 from PBU 612. The LCC of PBU 611 may initiate the first predetermined countermeasure that affects a ramp-up current in PBU 611 upon receiving the first control signal and initiate the second predetermined countermeasure that affects a ramp-down current in PBU 611 upon receiving the second control signal.

Illustratively, architecture 600 communicates nominal dynamic power usage estimates, independent of the IC's current supply voltage levels and independent of the current clock speed. GPA 635 may transmit the determined array-level nominal dynamic power estimate to a power clock management controller (PCMC 640) or other power management unit. PCMC 640 receives the array-level nominal dynamic power estimate from GPA 635. If desired, PCMC 640 scales the array-level nominal dynamic power estimate with frequency and voltage scale factors that are based on the actual clock frequency and measured supply voltage to obtain an estimated actual dynamic power. Illustratively, PCMC 640 determines a static power (leakage) estimate for the array based on the measured supply voltage and the die temperature. PCMC 640 adds the dynamic power and static power estimates to obtain a total estimated power.

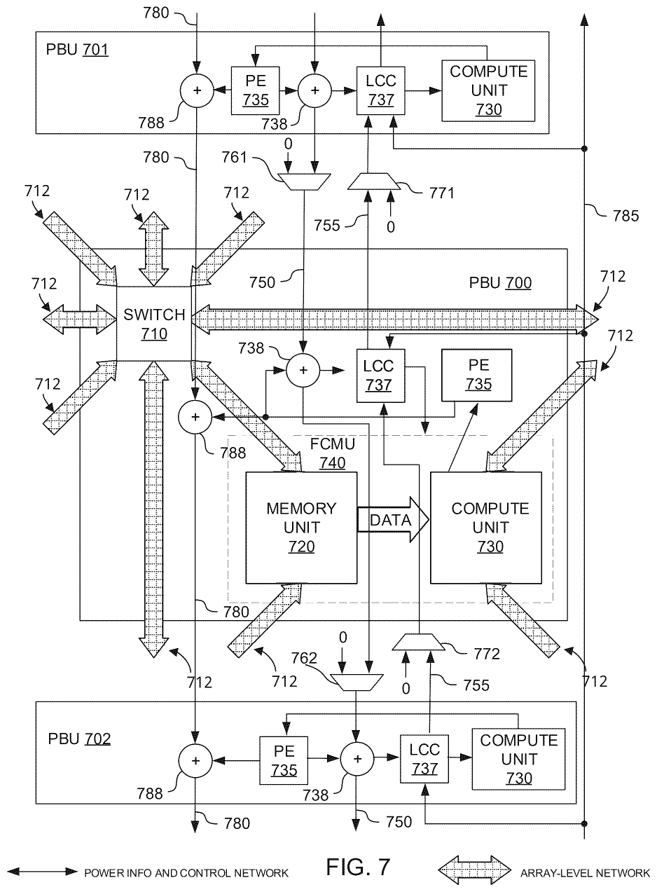

FIG. 7 illustrates an example power base unit (PBU) 700 with neighboring PBUs 701 and 702. As shown in FIG. 7, PBUs 701, 700, and 702 are arranged in a column. If desired, PBUs 701, 700, and 702 may be arranged in a row instead. As an example, PBU 700 is shown in more detail than PBUs 701 and 702. If desired, PBUs 701 and 702 may include the same components as PBU 700.

PBU 700 includes a switch 710 that is coupled with, for example, an ALN 712, a memory unit, for example memory unit 720, and a compute unit, for example compute unit 730 or a compute unit in a neighboring PBU (e.g., PBU 702). Memory unit 720 and compute unit 730 may jointly be part of an FCMU 740. Switch 710 may couple, via ALN 712, with one or more switches of neighboring PBUs (e.g., PBUs 701 and 702), one or more memory units (for example memory unit 720), and one or more compute units. PBU 700 further comprises a power estimator (PE) 735. PE 735 of each PBU 700, 701, 702 is configured to determine a dynamic power estimate dissipated at least by the compute unit 730 of that PBU. The PE 735 is coupled with the respective compute unit 730, and further with power information network 750 via local power accumulator 738. As shown in FIG. 7, an adder may implement local power accumulator 738.

Illustratively, the local power accumulator 738 of PBU 701 sends the dynamic power estimate from PE 735 of PBU 701 to the local control circuit (LCC) 737 of PBU 701 and via the power information network 750 to the local accumulator 738 of PBU 700. The local power accumulator 738 of PBU 700 adds the dynamic power estimate from PBU 701 with a dynamic power estimate from PE 735 of PBU 700 and sends the accumulated dynamic power estimate to the LCC 737 of PBU 700 and via the power information network 750 to PBU 702. The local power accumulator 738 of PBU 702 may add the dynamic power estimate from PBU 700 with a dynamic power estimate from PE 735 of PBU 702 and send the accumulated dynamic power estimate to LCC 737 of PBU 702 and via the power information network 750 to a local power accumulator of a neighboring PBU.

The local control circuit 737 of PBU 700 is configured to generate a first control signal and initiate a first predetermined countermeasure that affects a ramp-up current in the PBU 700 upon determining that the local nominal dynamic power estimate exceeds a first threshold. For example, the FCMU 740 may include a first-in first-out (FIFO) buffer that is coupled to the compute unit 730, and the first predetermined countermeasure may include an insertion of a predetermined number of bubbles into the FIFO.

The local control circuit 737 of PBU 700 is further configured to generate a second control signal and initiate a second predetermined countermeasure that affects a ramp-down current in the PBU 700 upon determining that the local nominal dynamic power estimate is below a second threshold. For example, the second predetermined countermeasure may include executing a predetermined number of dummy operations in the compute unit 730. Illustratively, the compute unit 730 may include an unused accumulator (i.e., an accumulator that is unused by the current configuration), and one such dummy operation may include accumulating any numbers greater than zero. By way of example, the predetermined countermeasures may follow a predefined, but configurable pattern in which the number of inserted bubbles into the FIFO or the number of dummy operations executed by the compute unit 730 is configurable.

LCC 737 may transmit the first control signal or the second control signal via power control network 755 to the LCC 737 of PBU 701. The LCC 737 of PBU 701 receives the first control signal or the second control signal from the LCC 737 of PBU 700 via the power control network 755. In response to receiving the first control signal, the LCC 737 of PBU 701 may initiate the first predetermined countermeasure that affects a ramp-up current in PBU 701. In response to receiving the second control signal, the LCC 737 of PBU 701 may initiate the second predetermined countermeasure that affects a ramp-down current in PBU 701.

In some implementations, PBU 700 may include an additional power accumulator 788 for the array-level nominal dynamic power estimation. In these implementations, the additional power accumulator 788 of PBU 701 is an adder that sends the dynamic power estimate from PE 735 of PBU 701 via the power information network 780 to the additional power accumulator 788 of PBU 700. The additional power accumulator 788 of PBU 700 adds the dynamic power estimate from PBU 701 with a dynamic power estimate from PE 735 of PBU 700 and sends the accumulated dynamic power estimate via the power information network 780 to PBU 702. The additional power accumulator 788 of PBU 702 may add the dynamic power estimate from PBU 700 with a dynamic power estimate from PE 735 of PBU 702 and send the accumulated dynamic power estimate via the power information network 780 to an additional power accumulator of a neighboring PBU or to a CPA (e.g., CPA 620 of FIG. 6).

Illustratively, an additional power information network 785 may couple the CPA to the local control circuits 737 in the different PBUs 701, 700, 702. The respective LCCs 737 may implement countermeasures that affect a ramp-up current or a ramp-down current in the corresponding PBU based on the control signal on the additional power information network 785. If desired, the control signal on the additional power information network 785 may be generated by a global control circuit (GCC) such as GCC 637 of FIG. 6 based on a global dynamic power estimation.

FIG. 7 shows two separate power information networks 750 and 780 for accumulating the dynamic power and two power control networks 755 and 785. However, if desired, the two power information networks 750 and 780 may be implemented as separate portions of the same power information network. For example, power information network 750 may include 8-bit connections and power information network 780 may include 10-bit connections, which can be combined into a single 18-bit power information network in which the 8 most significant bits (MSBs) are reserved for the local nominal dynamic power estimate and the 10 least significant bits (LSBs) are reserved for the array-level nominal dynamic power estimate. Similarly, the two power control networks 755 and 785 may be implemented as separate portions of a same power control network, if desired.

Illustratively, the power information network 750 may include multiplexers 761 between neighboring PBUs. For example, multiplexer 761 between PBU 700 and PBU 702 may have a first input that is coupled to PBU 700, a second input that is coupled to zero, an output that is coupled to PBU 702, and a configurable selector input. The configurable selector input may be configured to couple the first input to the output when the PBUs 700 and 702 are in a same local group with a common local ramp-up current or ramp-down current control, and the configurable selector input may be configured to couple the second input to the output when the PBUs 700 and 702 are in separate local groups with a separate local ramp-up current or ramp-down current control.

Similarly, the power control network 755 may include multiplexers 771 between neighboring PBUs. For example, multiplexer 771 between PBU 700 and PBU 701 may have a first input that is coupled to PBU 700, a second input that is coupled to zero, an output that is coupled to PBU 701, and a configurable selector input. The configurable selector input may be configured to couple the first input to the output when the PBUs 700 and 701 are in a same local group with a common local ramp-up current or ramp-down current control, and the configurable selector input may be configured to couple the second input to the output when the PBUs 700 and 701 are in separate local groups with a separate local ramp-up current or ramp-down current control.

For example, consider the scenario in which PBUs 701 and 700 form a local group with a common local ramp-up current and ramp-down current control, whereas PBU 702 is in a separate local group with a separate local ramp-up current and ramp-down current control. In this scenario, multiplexer 761 between PBU 701 and PBU 700 is configured to couple the output of local power accumulator 738 of PBU 701 with the input of local power accumulator 738 of PBU 700, while multiplexer 761 between PBU 700 and PBU 702 is configured to couple zero to the input of local power accumulator 738 of PBU 702. Similarly, multiplexer 771 between PBU 700 and PBU 701 is configured to couple the output of LCC 737 of PBU 700 with the input of LCC 737 of PBU 701, while multiplexer 771 between PBU 702 and PBU 700 is configured to couple zero to the input of LCC 737 of PBU 700.

In some implementations, PBUs 701, 700, and 702 are arranged in a row, and the dedicated wiring of power information network 750 and power control network 755 couples PBUs 701, 700, and 702 within a row of the array of PBUs in a daisy-chain. In other implementations, PBUs 701, 700, and 702 are arranged in a column, and the dedicated wiring of power information network 750 and power control network 755 couples PBUs 701, 700, and 702 within a column of the array of PBUs in a daisy-chain. For simplicity and brevity, however, only power information networks 750 and 780 and power control networks 755 and 785 that couple PBUs within a column of the array of PBUs are described hereinafter by way of example representative of both implementations (i.e., representative of power information networks 750, 780 and power control networks 755, 785 that couple PBUs in columns and/or in rows).

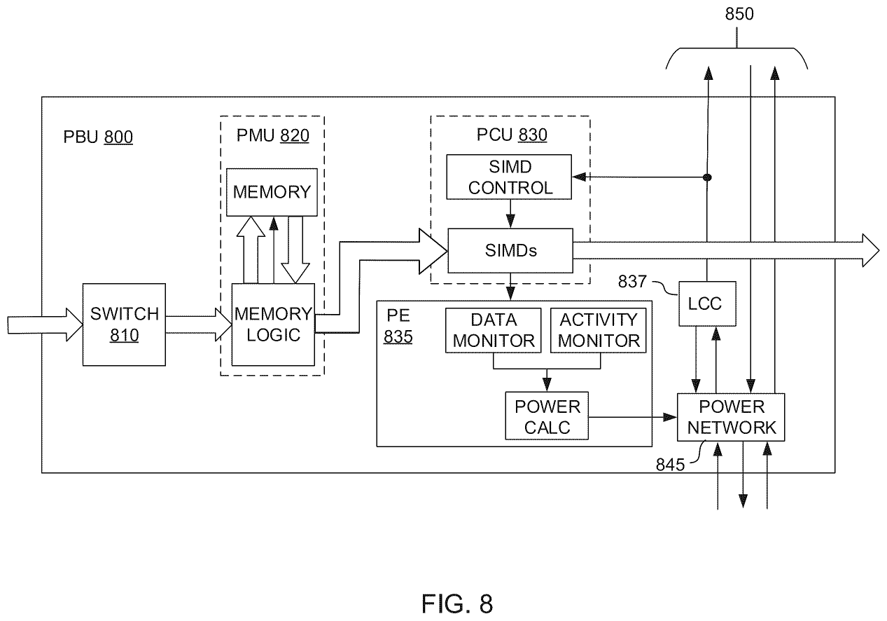

FIG. 8 illustrates details of a power base unit 800 implementation. Power base unit 800 monitors vector data switch activity to improve power estimation accuracy. Power base unit 800 includes a switch 810, a pattern memory unit (PMU) 820, and a pattern compute unit (PCU) 830. As shown in FIG. 8, PBU 800 may further include PE 835 that is coupled to PCU 830 and power network 845. PE 835 is coupled with power information and control network 850 via power network 845.

Power network 845 may include a local power accumulator (e.g., local power accumulator 738 of FIG. 7) for determining a local nominal dynamic power estimate. If desired, power network 845 may include an additional power accumulator (e.g., power accumulator 788 of FIG. 7) for determining an array-level nominal dynamic power estimate. Power information and control network 850 may couple the power network 845 with neighboring PBUs and/or a column power accumulator.

Illustratively, LCC 837 is coupled to power network 845, to PCU 830, and to a neighboring PBU via the power information and control network 850. For example, LCC 837 may generate and transmit a control signal for initiating countermeasures that affect a ramp-up current or a ramp-down current to the neighboring PBU via the power information and control network 850. LCC 837 is also configured to initiate countermeasures that affect a ramp-up or ramp-down current in the PBU 800. For example, LCC 837 may determine an appropriate countermeasure and apply the countermeasure to PCU 830. The decision to initiate the countermeasures may be based on a local nominal dynamic power estimate from the power network 845. For example, LCC 837 may compare the local nominal dynamic power estimate to a first threshold and to a second threshold. In response to determining that the local nominal dynamic power estimate exceeds the first threshold, LCC 837 may initiate a countermeasure that affects a ramp-up current in the PCU 830. In response to determining that the local nominal dynamic power estimate is below the second threshold, LCC 837 may initiate a countermeasure that affects a ramp-down current in the PCU 830.

PE 835 measures activity of the one or more SIMDs included in pattern compute unit (PCU) 830 (or ALUs or other processor elements in a compute unit). A SIMD is a type of parallel processor that executes a single instruction on multiple data. The SIMD may have a configuration input that receives, for example, an opcode that determines the instruction type. It may have multiple A inputs for multiple different data to simultaneously operate on, and a B input to receive a common operand. An instruction may be to multiply the multiple data at the A inputs with the common operand (coefficient) on the B input, such as ‘multiply all A inputs with B’.

The power dissipated in a SIMD may depend on its internal architecture, and may include factors such as an idle power, power dependent on the operation being performed, power dependent on the number of operand bits being toggled since a previous (clock) cycle, and power dependent on whether one of the operands A or B equals zero. For example, a multiplication in which the B inputs receives the zero operand may not use any dynamic power. A multiplication in which one of the A operands equals zero may not use any dynamic power in the channel of that A operand. Zero-value monitoring is of particular importance for matrix multiplication, one of the most common operations in neural networks. By monitoring both the data switch activity (bits toggling), the value of the operands (zero values), and the type of operation, PE 835 may calculate a quite accurate estimate of the power calculated in the SIMD.

If desired, the first and second thresholds may be selected based on a previously determined local nominal dynamic power estimate. For example, the LCC 837 may store a predetermined number of first and second thresholds and select one of the first thresholds and/or one of the second thresholds based on the local nominal dynamic power estimate determined during a prior time period. If desired, the prior time period may have occurred during an iteration that is temporarily immediately before determining the local nominal dynamic power estimate. As an example, consider the scenario in which the LCC 837 stores two different first thresholds (e.g., a greater first threshold and a smaller first threshold) and two different second thresholds (e.g., a greater second threshold and a smaller second threshold). Consider further that the local nominal dynamic power estimate determined during a prior time period corresponds to a number of currently active SIMD stages (e.g., SIMD 521 to 526 of FIG. 5). In this scenario, in response to determining that the number of currently active SIMD stages is smaller than a third threshold, LCC 837 uses the smaller first threshold for generating the first local control signal (i.e., for ramp-up current control) and the smaller second threshold for generating the second local control signal (i.e., for ramp-down current control), and in response to determining that the number of currently active SIMD stages is greater than or equal to the third threshold, LCC 837 uses the greater first threshold for generating the first local control signal (i.e., for ramp-up current control) and the greater second threshold for generating the second local control signal (i.e., for ramp-down current control), In the current scenario, LCC 837 uses two first thresholds and two second thresholds. However, LCC 837 may use any number of first and second thresholds instead. For example, LCC 837 may use three, four, five, or more first and second thresholds. LCC 837 may use a same number of first and second thresholds. If desired, LCC 837 may use a different number of first and second thresholds. Illustratively, LCC 837 may increase the selected first threshold with the previously determined local nominal dynamic power estimate, and decrease the second threshold with the previously determined local nominal dynamic power estimate. For example, in the scenario above, LCC 837 may periodically compute a new first threshold and a new second threshold based on the current number of active SIMD stages.

PCU 835 may include a pipeline of SIMDs operating on the input data, with successive SIMDs configured for a series of successive operations. Thus, PE 835 may monitor each of the SIMDs, and may monitor all or part of the data channels that enter pattern compute unit (PCU) 830, to get a comprehensive estimate of the power dissipation. PE 835 may include separate circuits for monitoring bit toggling activity, and data values. PE 835 calculates the resulting total power estimate for pattern compute unit (PCU) 830 and may provide a timestamp for the estimate. PE 835 may communicate the results to neighboring PBUs and/or to a global power accumulator (GPA) via the power information and control network 850, ensuring that power estimates are available on a chip or system level much faster than other methods might be able to. Some implementations may use timestamps only locally within each power base unit, utilizing known network latency of the global power data network to ensure synchronization. In those applications, the PCU is responsible for power data synchronization. Other implementations may provide the timestamps globally, so that PE 835 transmits timestamped power data to the GPA. In those implementations, each the PCU, the CPA or RPA, and the GPA are responsible for power data synchronization.

In some implementations, the PE 835 may trade off accuracy of the total power estimate for PCU 830 against a quicker result by calculating a total power estimate for PCU 830 based solely on the number of total active SIMDs in PCU 830. For example, the activity monitor of PE 835 may count the number of total active SIMDs in PCU 830 to the power calculator, which may provide a corresponding total power estimate to the power network 845.

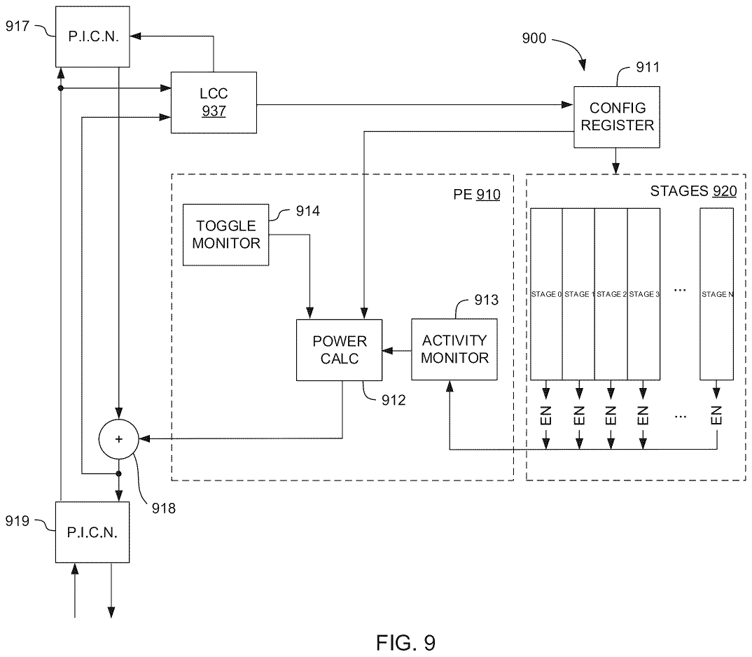

FIG. 9 illustrates details of an example PE 910 for nominal dynamic power estimation in a PBU 900. In some implementations, PBU 900 may include a switch and a PMU. As shown in FIG. 9, PBU 900 includes a pipeline of N+1 SIMD stages 920 (or other ALU or processor core stages), including an initial stage 0 and stages 1 through N. The various stages may have equal or different capabilities. The stages may include multiple lanes, and PE 910 shows the circuits needed for each such lane to estimate its power. The stages may be statically configured, for example by information in a configuration register 911, or dynamically configured, for example by information in an instruction register. If the PBU is included in a GPU, then GPU cores may dynamically fetch instructions (dynamic functionality information) from memory and place the current instruction in an instruction register. If the PBU is included in a CGR processor, then reconfigurable units may include a configuration register in which the static functionality information for each of the stages is stored. The configuration register or instruction register provides functionality information for each of the stages, as well as for the power calculation unit 912. An activity monitor 913 determines if each stage is active, and provides the activity information to power calculation unit 912. The toggle monitor 914 determines data related information, such as the amount of toggling, zero values, and any other data activity parameters known to impact power usage, and provides that information to power calculation unit 912.

Power calculation unit 912 may use the stages' activity information from activity monitor 913 and the functionality configuration from configuration register 911. Power calculation unit 912 uses a power usage model of a stage to calculate (estimate) the power usage of PBU 900 based on the information from configuration register 911, activity monitor 913, and toggle monitor 914 In some implementations, power calculation unit 912 may calculate (estimate) the power usage of PBU 900 based on a subset of the information received from configuration register 911, activity monitor 913, and toggle monitor 914. As an example, power calculation unit 912 may calculate (estimate) the power usage of PBU 900 based solely on the information received from the activity monitor 913. As another example, power calculation unit 912 may calculate (estimate) the power usage of PBU 900 based solely on the information received from the toggle monitor 914. As yet another example, power calculation unit 912 may calculate (estimate) the power usage of PBU 900 based solely on the information received from the configuration register 911. As yet another example, power calculation unit 912 may calculate (estimate) the power usage of PBU 900 based on any combination of information received from the configuration register 911, the activity monitor 913, or the toggle monitor 914. The activity monitor 913 and/or the toggle monitor 914 can be omitted in implementations in which the power calculation unit 912 calculates (estimates) the power usage of PBU 900 without relying on the information provided by the respective activity monitor 913 or toggle monitor 914.

Illustratively, PBU 900 includes a power information and control network interface 917 and a power information and control network interface 919. In some implementations, PBU 900 may, as drawn, receive power information from PEs that are part of the same local group for ramp-up and ramp-down current control (e.g., local group 680 of FIG. 6) higher in the column in power information and control network interface 917, add the estimated nominal dynamic power determined by PE 910 to the received power information in adder 918, and transmit the accumulated estimated nominal dynamic power to a PBU lower in the column via power information and control network interface 919, while both, the received power information and the estimated nominal dynamic power determined by PE 910 are transmitted via power information and control network interface 919 to a CPA for accumulation of the array-level nominal dynamic power.

In other implementations, PBU 900 may include an additional power accumulator for the array-level nominal dynamic power estimation (e.g., additional power accumulator 788 of FIG. 7). In these implementations, the additional power accumulator of PBU 900 adds the estimated nominal dynamic power determined by PE 910 to the received power information and sends the accumulated dynamic power estimate via the power information and control network interface 919 to a neighboring PBU or to the CPA.

Power calculation unit 912, power information and control network interface 917, and power information and control network interface 919 may all operate with timestamps to ensure that data of the PEs is aligned with similar data from elsewhere in a column, thereby preventing that activity spikes get lost due to filtering effects.

By way of example, PBU 900 includes a local control circuit (LCC) 937. LCC 937 receives the accumulated estimated power from adder 918 and determines whether the accumulated estimated power exceeds a predetermined threshold that is indicative of a large ramp-up current or is below another predetermined threshold that is indicative of a large ramp-down current. In response to determining that the accumulated estimated power exceeds the predetermined threshold that is indicative of a large ramp-up current, LCC 937 initiates a predetermined countermeasure that affects the ramp-up current in PBU 900. In response to determining that the accumulated estimated power is below the predetermined threshold that is indicative of a large ramp-down current, LCC 937 initiates a predetermined countermeasure that affects the ramp-down current in PBU 900. LCC 937 may also initiate these predetermined countermeasures in response to receiving a corresponding control signal from power information and control network interface 919. The corresponding control signal may have been generated by an LCC in another PBU, by a global control circuit (GCC) such as GCC 637 of FIG. 6.

Illustratively, LCC 937 may initiate countermeasures that affects the ramp-up or ramp-down current by providing configuration information to configuration register 911 for reconfiguring the SIMD stages 920. As an example of a countermeasure that affects the ramp-down current, LCC 937 may provide configuration information to configuration register 911 such that SIMD stages 920 are configured to perform dummy operations. As an example of a countermeasure that affects the ramp-up current, LCC 937 may provide configuration information to configuration register 911 such that SIMD stages 920 insert bubbles in a FIFO buffer.

In response to determining that the accumulated estimated power exceeds the predetermined threshold that is indicative of a large ramp-up current or that the accumulated estimated power is below the predetermined threshold that is indicative of a large ramp-down current, LCC 937 generates a corresponding control signal. LCC 937 transmits this control signal to a neighboring PBU via power information and control network interface 917.

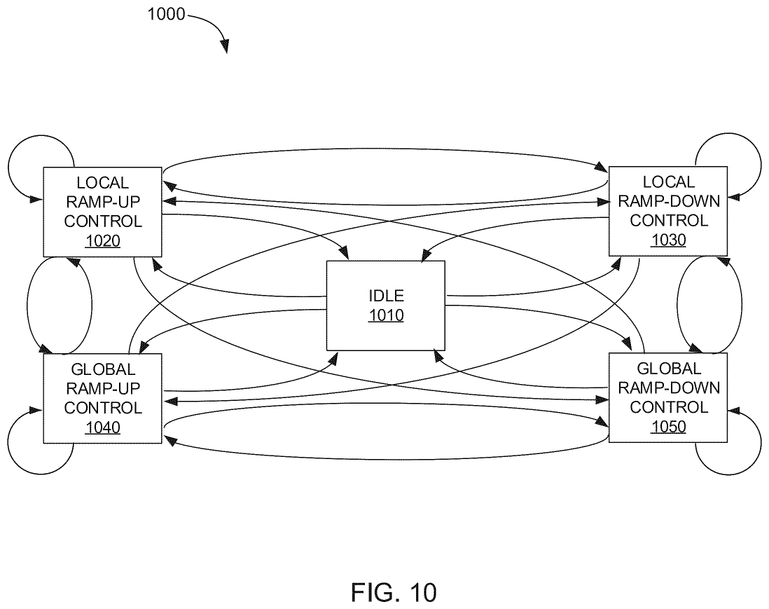

FIG. 10 shows an illustrative finite state machine (FSM) 1000 for controlling a ramp-up current or a ramp-down current in a compute unit of a PBU such as PCU 830 of PBU 800 of FIG. 8. Illustratively, an LCC such as LCC 837 of FIG. 8 may implement FSM 1000. As shown in FIG. 10, FSM 1000 includes the states “Idle” 1010, “Local ramp-up control” 1020, “Local ramp-down control” 1030, “Global ramp-up control” 1040, and “Global ramp-down control” 1050.

FSM 1000 is in state “Local ramp-up control” 1020 or transitions into state “Local ramp-up control” 1020, when any LCC of the local group to which the PBU belongs (e.g., the LCC in PBU 611 of local group 680 of FIG. 6) has triggered a first control signal that affects a ramp-up current in the PBU. In the “Local ramp-up control” state 1020, the LCC initiates a first predetermined countermeasure that affects a ramp-up current in the PBU. For example, the LCC may store predetermined countermeasures in form of a pattern register for controlling a local ramp-up current. In the example described with reference to FIG. 6 in which a first-in first-out (FIFO) buffer is coupled to the compute unit of PBU 612, and the first predetermined countermeasure includes an insertion of a predetermined number of bubbles into the FIFO, the pattern register for controlling the local ramp-up current may include a predetermined number of bits in a predetermined sequence of zeros and ones, whereby a one can indicate that a pipeline bubble is inserted into the FIFO, and a zero can indicate that no action is taken. As an example, the pattern register may include 64 bits that is divided into eight segments of eight bits. The first segment is loaded into a shift register that completes eight bits shifting in eight cycles. Each segment can be configured to repeat once or several times. After a segment is completed, the next segment is loaded into the shift register. After the completion of the last segment, a “Done” signal may be asserted, and the FSM 1000 may transition into the “Idle” state 1010.

FSM 1000 is in state “Local ramp-down control” 1030 or transitions into state “Local ramp-down control” 1030, when any LCC of the local group to which the PBU belongs (e.g., the LCC in PBU 611 of local group 680 of FIG. 6) has triggered a second control signal that affects a ramp-down current in the PBU. In the “Local ramp-down control” state 1030, the LCC initiates a second predetermined countermeasure that affects a ramp-down current in the PBU. For example, the LCC may store predetermined countermeasures in form of a pattern register for controlling a local ramp-down current. In the example described with reference to FIG. 6 in which a FIFO buffer is coupled to the compute unit of PBU 612, and the second predetermined countermeasure includes an insertion of a predetermined number of dummy operations into the FIFO, the pattern register for controlling the local ramp-down current may include a predetermined number of bits in a predetermined sequence of zeros and ones, whereby a one can indicate that a dummy operation is inserted into the FIFO, and a zero can indicate that no action is taken. As an example, the pattern register may include 64 bits that are divided into eight segments of eight bits. The second segment is loaded into a shift register that completes eight bits shifting in eight cycles. Each segment can be configured to repeat once or several times. After a segment is completed, the next segment is loaded into the shift register. After the completion of the last segment, a “Done” signal may be asserted, and the FSM 1000 may transition into the “Idle” state 1010.

FSM 1000 is in state “Global ramp-up control” 1040 or transitions into state “Global ramp-up control” 1040, when the GCC (e.g., GCC 637 of FIG. 6) has triggered a first global control signal that affects a global ramp-up current in all PBUs in the array of PBUs. In the “Global ramp-up control” state 1040, the LCC or another entity in the PBUs initiates a third predetermined countermeasure that affects a ramp-up current in the respective PBU. For example, the LCC may store predetermined countermeasures in form of a pattern register for controlling a global ramp-up current. In the example described with reference to FIG. 6 in which a FIFO buffer is coupled to the compute unit of PBU 612, and the third predetermined countermeasure includes an insertion of a predetermined number of bubbles into the FIFO, the pattern register for controlling the global ramp-up current may include a predetermined number of bits in a predetermined sequence of zeros and ones, whereby a one can indicate that a pipeline bubble is inserted into the FIFO, and a zero can indicate that no action is taken. In some implementations, the pattern register for controlling the global ramp-up current may be the same as the pattern register for controlling the local ramp-up current. In other implementations, the pattern register for controlling the global ramp-up current may be different than the pattern register for controlling the local ramp-up current. As an example, the pattern register may include 64 bits that is divided into eight segments of eight bits. The first segment is loaded into a shift register that completes eight bits shifting in eight cycles. Each segment can be configured to repeat once or several times. After a segment is completed, the next segment is loaded into the shift register. After the completion of the last segment, a “Done” signal may be asserted, and the FSM 1000 may transition into the “Idle” state 1010.

FSM 1000 is in state “Global ramp-down control” 1050 or transitions into state “Global ramp-down control” 1050, when the GCC (e.g., GCC 637 of FIG. 6) has triggered a second global control signal that affects a global ramp-down current in all PBUs of the array of PBUs. In the “Global ramp-down control” state 1050, the LCC or another entity in the PBUs initiates a fourth predetermined countermeasure that affects a ramp-down current in the respective PBU. For example, the LCC may store predetermined countermeasures in form of a pattern register for controlling a global ramp-down current. In the example described with reference to FIG. 6 in which a FIFO buffer is coupled to the compute unit of PBU 612, and the fourth predetermined countermeasure includes an insertion of a predetermined number of dummy operations into the FIFO, the pattern register for controlling the global ramp-down current may include a predetermined number of bits in a predetermined sequence of zeros and ones, whereby a one can indicate that a dummy operation is inserted into the FIFO, and a zero can indicate that no action is taken. In some implementations, the pattern register for controlling the global ramp-down current may be the same as the pattern register for controlling the local ramp-down current. In other implementations, the pattern register for controlling the global ramp-down current may be different than the pattern register for controlling the local ramp-down current. As an example, the pattern register may include 64 bits that are divided into eight segments of eight bits. The second segment is loaded into a shift register that completes eight bits shifting in eight cycles. Each segment can be configured to repeat once or several times. After a segment is completed, the next segment is loaded into the shift register. After the completion of the last segment, a “Done” signal may be asserted, and the FSM 1000 may transition into the “Idle” state 1010.

FSM 1000 remains in the state “Idle” 1010 for as long as no control signal for ramp-up or ramp-down current control has been received by the LCC. In the above example, the respective pattern register includes 64 bits. However, the respective pattern register can have any number of bits. In some implementations, the four pattern registers can have the same number of bits. In other implementations, at least two of the pattern registers can have different number of bits.

In the above example, the pattern registers are divided into eight segments. However, the pattern registers may be divided into any number of segments. For example, the pattern register may be divided into two, three, four or more segments if desired.

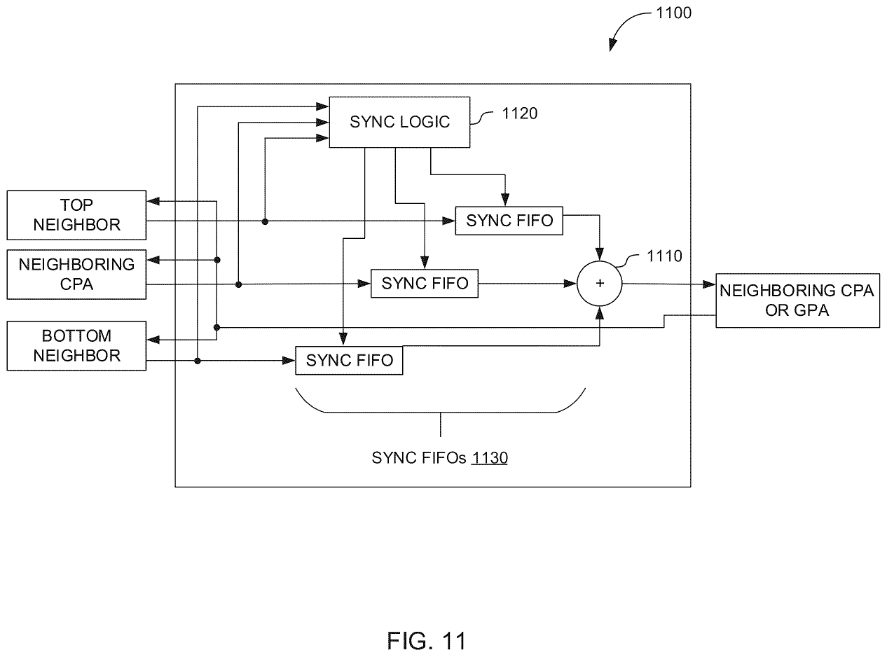

FIG. 11 illustrates details of an example column power accumulator (CPA) 1100. The CPA 1100 includes a three-input adder 1110, which adds the power estimates from the column above, the column below, and the neighboring CPA if any. CPA 1100 sends the accumulated result to a neighboring CPA, and ultimately to a global power accumulator (e.g., GPA 635 of FIG. 6). It may further include synchronization logic 1120 which reads timestamps received from the three inputs, and synchronizes the received power estimates in synchronization FIFOs 1130.

The CPA 1100 also receives a ramp control signal that can indicate that a ramp-up current control or a ramp-down current control is required. The ramp control signal originates from a global control circuit (e.g., GCC 637 of FIG. 6). CPA 1100 transmits the received ramp control signal to the PBUs in the column above, the PBUs in the column below, and to the neighboring CPA, if any.

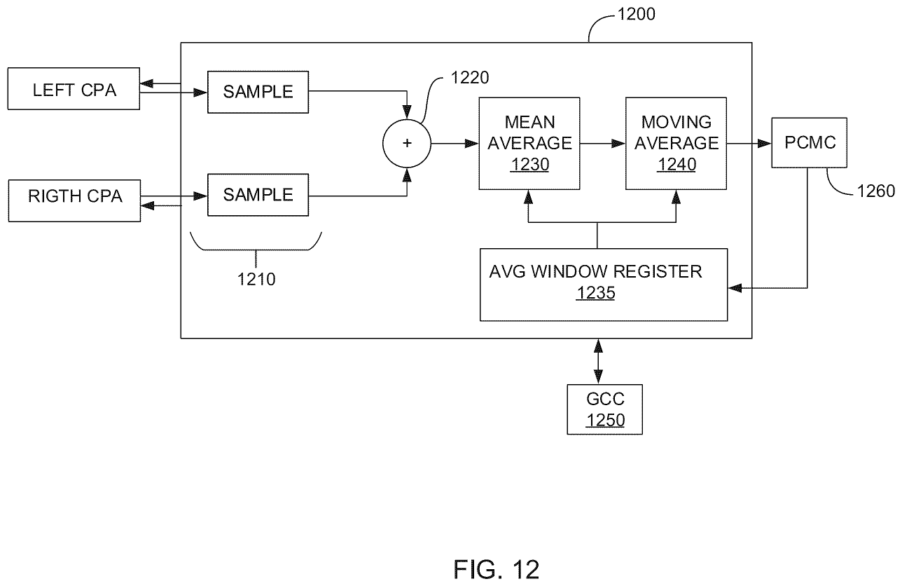

FIG. 12 illustrates details of an example global power accumulator 1200 that determines the array-level nominal dynamic power estimate. GPA 1200 has a first CPA input (left CPA) and a second CPA input (right CPA). GPA 1200 includes sample circuits 1210 coupled with the first CPA input and the second CPA input, two-input adder 1220 with its inputs coupled to the outputs of sample circuits 1210, and a first averaging stage 1230 with a data input coupled with the output of adder 1220 and a configuration input coupled with the averaging window register 1235 output. The averaging window register 1235 is set by a power clock management controller 1260 (e.g., PCMC 640 of FIG. 6). The second averaging stage 1240 has a data input coupled with the output of first averaging stage 1230 and a configuration input coupled with the averaging window register 1235 output. Its output provides the information for the PCMC 1260. GPA 1200 accumulates the power from CPAs and sends the averaged power to the PCMC 1260. The averaging window is controlled by PCMC 1260. First, GPA 1200 samples the input data from the CPAs in sample circuits 1210. The sampled data goes through two stages of averaging logic. The first averaging stage 1230 calculates a mean average. First averaging stage 1230 calculates the averaged power in a range from nanoseconds to milliseconds, configured by the PCMC 1260 in averaging window register 1235. Second averaging stage 1240 calculates a moving average power, which it provides to the PCMC 1260.

As shown in FIG. 12, GPA 1200 is also coupled to global control circuit GCC 1250. GCC 1250 may receive the array-level nominal dynamic power estimate from GPA 1200 and determine whether countermeasures that affect a ramp-up current or a ramp-down current are required for the entire reconfigurable processor IC based on the array-level nominal dynamic power estimate. Illustratively, GCC 1250 may store thresholds and include a ramp-up control circuit and a ramp-down control circuit (e.g., ramp-up control circuit 1040 and ramp-down control circuit 1050 of FIG. 10A). If desired, the ramp-up control circuit in GCC 1250 may compare the array-level nominal dynamic power estimate from GPA 1200 with the first threshold, generate a ramp-up current control signal, and transmit the ramp-up current control signal to the GPA 1200 upon determining that the array-level nominal dynamic power estimate exceeds the first threshold. Similarly, the ramp-down control circuit in GCC 1250 may compare the array-level nominal dynamic power estimate from GPA 1200 with the second threshold, generate a ramp-down current control signal, and transmit the ramp-down current control signal to the GPA 1200 upon determining that the array-level nominal dynamic power estimate is below the second threshold.

In response to receiving a ramp-up or ramp-down control signal from GCC 1250, GPA 1200 may transmit the ramp-up or ramp-down control signal to the left CPA and to the right CPA. In some implementations, GCC 1250 may transmit the ramp-up or ramp-down control signal directly to the left CPA and to the right CPA without passing through GPA 1200.

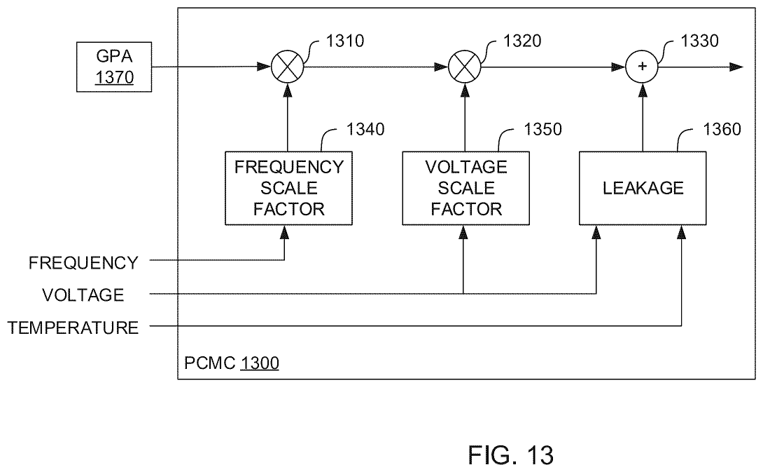

FIG. 13 illustrates details of an example PCMC 1300 that determines a global total power estimate. The power information from the GPA 1370 is an estimate at a nominal clock frequency and supply voltage which may not coincide with the actual clock frequency and supply voltage. PCMC 1300 dynamically scales the data from GPA 1370 with a frequency scale factor and a voltage to get the final dynamic power. PCMC 1300 also determines the leakage based on the chip temperature and voltage. Some implementations determine the leakage from a lookup table (LUT) with the measured supply voltage and the clock frequency as its input variables. Other implementations may calculate the leakage based on a leakage model, using the measured supply voltage and the temperature as its input variables. PCMC 1300 adds the final dynamic power and the leakage (static power) to obtain the final total power, which it provides at its output, for example for use by a dynamic frequency and voltage scaling (DFVS) controller.

PCMC 1300 includes multiplier 1310, multiplier 1320, adder 1330, frequency scale factor circuit 1340, voltage scale factor circuit 1350, and leakage circuit 1360. Multiplier 1310 has a data input coupled with a PCMC data input that may receive the final total power data calculated by the GPA 1370, and a frequency scale factor input coupled with an output of frequency scale factor circuit 1340. Frequency scale factor circuit 1340 determines the frequency scale factor from the actual clock frequency. For example, if the GPA estimate is based on a nominal clock frequency of 1 GHz and the actual clock frequency is 3.5 GHz, then the frequency scale factor may be 3.5. In some implementations, frequency scale factor circuit 1340 includes a LUT. In other implementations, frequency scale factor circuit 1340 performs a mathematical operation on the actual clock frequency signal at its input to determine the frequency scale factor for its output. Multiplier 1310 scales the power estimate from the GPA by multiplying the power estimate from the GPA with the frequency scale factor.

Multiplier 1320 has a data input coupled with the output of multiplier 1310 and a voltages scale factor input coupled with an output of voltage scale factor circuit 1350. Voltage scale factor circuit 1350 determines the voltage scale factor from the measured supply voltage. The voltage scale factor may not be proportional to the measured supply voltage and may be determined from a voltage scaling model. The voltage scaling model may be stored as a table in a LUT included in voltage scale factor circuit 1350. In some cases, the voltage scaling model may be implemented as a mathematical operation performed by voltage scale factor circuit 1350. Multiplier 1320 scales the power estimated received from multiplier 1310 by multiplying it with the voltage scale factor to obtain the total dynamic power.

However, even though PCMC 1300 determines the total dynamic power more accurately than GPA 1370, the total dynamic power determined by PCMC 1300 may not be used to determine whether countermeasures that affect a ramp-up current or a ramp-down current are required for the entire reconfigurable processor IC. Instead, the global total power estimate from the GPA 1370 may be used to determine (e.g., by GCC 637 of FIG. 6) whether countermeasures that affect a ramp-up current or a ramp-down current are required for the entire reconfigurable processor IC. In fact, GPA 1370 may provide a global total power estimate that deviates less than a predetermined tolerance from the total estimated power determined by PCMC 1300 in a much shorter period of time during which countermeasures can be deployed that significantly affect the ramp-up current or the ramp-down current.

Adder 1330 has a data input coupled with the output of multiplier 1320 and a leakage data input coupled with an output of leakage circuit 1360. The leakage power or static power of an integrated circuit is determined by its circuitry (which is fixed), the supply voltage available to the circuitry, and the die temperature. The supply voltage can be measured. The die temperature can be measured as well as estimated. In either case, leakage circuit 1360 receives the measured supply voltage and the measured or estimated die temperature as its input variables based on which it estimates the static power. For example, leakage circuit 1360 may include a LUT, or a circuit that performs a mathematical operation on the input variables. Adder 1330 adds the total dynamic power received from multiplier 1320 and the static power received from leakage circuit 1360 to obtain the total estimated power.

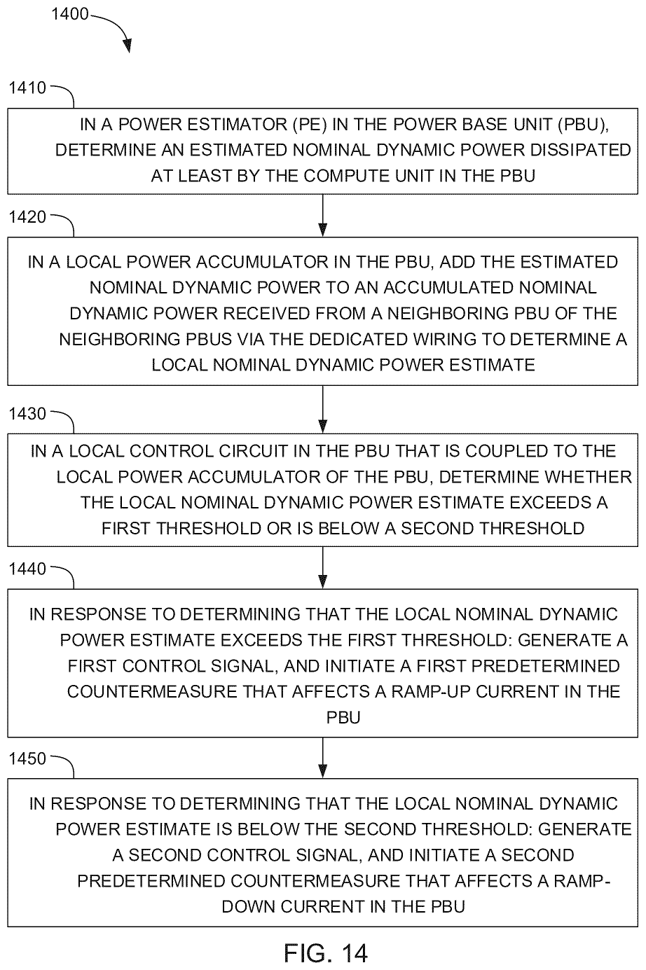

FIG. 14 illustrates an example method 1400 of operating a reconfigurable processor IC having multiple power base units (PBUs) arranged in an array of rows and columns with dedicated wiring that couples neighboring PBUs of the multiple PBUs, and wherein a PBU of the multiple PBUs comprises a compute unit. Method 1400 comprises:

At operation 1410, a power estimator (PE) in the PBU determines an estimated nominal dynamic power dissipated at least by the compute unit in the PBU. For example, the power estimator 735 of PBU 700 of FIG. 7 may determine an estimated nominal dynamic power dissipated by the compute unit 730 in PBU 700.

At operation 1420, a local power accumulator in the PBU adds the estimated nominal dynamic power to an accumulated nominal dynamic power received from a neighboring PBU of the neighboring PBUs via the dedicated wiring to determine a local nominal dynamic power estimate. For example, the local power accumulator 738 of PBU 700 of FIG. 7 may add the estimated nominal dynamic power from PE 738 of PBU 700 to an accumulated nominal dynamic power received from neighboring PBU 701 via the dedicated wiring of the power information network 750 to determine a local nominal dynamic power estimate.

During operation 1430, a local control circuit in the PBU that is coupled to the local power accumulator of the PBU determines whether the local nominal dynamic power estimate exceeds a first threshold or is below a second threshold. For example, the local control circuit 737 of PBU 700 of FIG. 7 may determine whether the local nominal dynamic power estimate received from local power accumulator 738 of PBU 700 exceeds a first threshold or is below a second threshold.

During operation 1440, in response to determining that the local nominal dynamic power estimate exceeds the first threshold, the local control circuit generates a first control signal and initiates a first predetermined countermeasure that affects a ramp-up current in the PBU. For example, in response to determining that the local nominal dynamic power estimate from local power accumulator 738 of PBU 700 of FIG. 7 exceeds the first threshold, the local control circuit 737 may generate a first control signal and initiate a first predetermined countermeasure that affects a ramp-up current in PBU 700.

During operation 1450, in response to determining that the local nominal dynamic power estimate is below the second threshold, the local control circuit generates a second control signal and initiates a second predetermined countermeasure that affects a ramp-down current in the PBU. For example, in response to determining that the local nominal dynamic power estimate from local power accumulator 738 of PBU 700 of FIG. 7 is below the second threshold, the local control circuit 737 may generate a second control signal and initiate a second predetermined countermeasure that affects a ramp-down current in PBU 700.

In some implementations, the local control circuit may transmit the first control signal or the second control signal via the dedicated wiring to the neighboring PBU. For example, the local control circuit 737 of PBU 700 of FIG. 7 may transmit the first control signal or the second control signal via the power control network 755 to neighboring PBU 701.

Illustratively, a global power accumulator may determine an array-level nominal dynamic power estimate by determining a sum of the estimated nominal dynamic power from the multiple PBUs. For example, global power accumulator 635 of FIG. 6 may determine an array-level nominal dynamic power estimate by determining a sum of the estimated nominal dynamic power from the multiple PBUs 610.

By way of example, the reconfigurable processor circuit may use additional dedicated wiring in the reconfigurable processor IC to transmit the estimated nominal dynamic power from the power estimators in the multiple PBUs to the global power accumulator.

In some implementations, a global control circuit that is coupled to the global power accumulator may determine whether the array-level nominal dynamic power estimate exceeds a first global threshold or whether the array-level nominal dynamic power estimate is below a second global threshold. For example, global control circuit 637 of FIG. 6 that is coupled to GPA 635 may determine whether the array-level nominal dynamic power estimate exceeds a first global threshold or whether the array-level nominal dynamic power estimate is below a second global threshold.

In response to determining that the array-level nominal dynamic power estimate exceeds the first global threshold, the global control circuit may generate a first global control signal and transmit the first global control signal via the additional dedicated wiring to the multiple PBUs to initiate the first predetermined countermeasure. For example, in response to determining that the array-level nominal dynamic power estimate exceeds the first global threshold, GCC 637 of FIG. 6 may generate a first global control signal and transmit the first global control signal via the additional dedicated wiring 655 to the multiple PBUs 610 to initiate the first predetermined countermeasure.

In response to determining that the array-level nominal dynamic power estimate is below the second global threshold, the global control circuit may generate a second global control signal and transmit the second global control signal via the additional dedicated wiring to the multiple PBUs to initiate the second predetermined countermeasure. For example, in response to determining that the array-level nominal dynamic power estimate is below the second global threshold, GCC 637 of FIG. 6 may generate a second global control signal and transmit the second global control signal via the additional dedicated wiring 655 to the multiple PBUs 610 to initiate the second predetermined countermeasure.

Illustratively, a power clock management controller (PCMC) that is coupled with the global power accumulator via the additional dedicated wiring may determine a static power estimate based at least on a voltage and a temperature of the reconfigurable processor IC. For example, PCMC 640 of FIG. 6 that is coupled with GPA 635 via the dedicated wiring 650 may determine a static power estimate based at least on a voltage and a temperature of the reconfigurable processor IC.

### Particular Implementations

Described implementations of the subject matter can include one or more features, alone or in combination.

As an example, a reconfigurable processor integrated circuit (IC), comprises multiple power base units (PBUs) arranged in an array of rows and columns with dedicated wiring that couples neighboring PBUs of the multiple PBUs, wherein a PBU of the multiple PBUs comprises a compute unit, a power estimator (PE) configured to determine an estimated nominal dynamic power dissipated at least by the compute unit in the PBU, a local power accumulator that adds the estimated nominal dynamic power to an accumulated nominal dynamic power received from a neighboring PBU of the neighboring PBUs via the dedicated wiring to determine a local nominal dynamic power estimate, and a local control circuit coupled to the local power accumulator. The local control circuit is configured to generate a first control signal and initiate a first predetermined countermeasure that affects a ramp-up current in the PBU upon determining that the local nominal dynamic power estimate exceeds a first threshold, and generate a second control signal and initiate a second predetermined countermeasure that affects a ramp-down current in the PBU upon determining that the local nominal dynamic power estimate is below a second threshold.

The foregoing example and other described implementations can each, optionally, include one or more of the following features:
(2) the power estimator is configured to determine the estimated nominal dynamic power based on monitoring input data bit toggling, instruction type, and processing activity of one or more reconfigurable data processing stages included in the compute unit.
(3) the local control circuit is further configured to transmit the first control signal or the second control signal via the dedicated wiring to the neighboring PBU.
(4) the neighboring PBU further comprises an additional local control circuit that receives the first control signal or the second control signal from the local control circuit via the dedicated wiring and that is configured to initiate the first predetermined countermeasure that affects a ramp-up current in the neighboring PBU upon receiving the first control signal, and initiate the second predetermined countermeasure that affects a ramp-down current in the neighboring PBU upon receiving the second control signal.
(5) the reconfigurable processor IC further comprises a first-in first-out (FIFO) buffer coupled to the compute unit, and wherein the first predetermined countermeasure comprises an insertion of a predetermined number of bubbles into the FIFO.
(6) the second predetermined countermeasure comprises executing a predetermined number of dummy operations in the compute unit.
(7) the dedicated wiring couples neighboring PBUs within a row of the array of PBUs in a daisy-chain.
(8) the dedicated wiring couples neighboring PBUs within a column of the array of PBUs in a daisy-chain.
(9) the dedicated wiring that couples the PBU with an additional neighboring PBU of the neighboring PBUs further comprises a multiplexer with a first input coupled to the PBU, a second input coupled to zero, an output coupled to the additional neighboring PBU, and a configurable selector input, wherein the configurable selector input is configured to couple the first input to the output when the PBU and the additional neighboring PBU are in a same local group with a common local ramp control, and wherein the configurable selector input is configured to couple the second input to the output when the PBU and the additional neighboring PBU are in separate local groups with a separate local ramp control.
(10) the reconfigurable processor IC further comprises a global power accumulator (GPA) that is configured to determine an array-level nominal dynamic power estimate by determining a sum of the estimated nominal dynamic power from the multiple PBUs; and additional dedicated wiring that transmits the estimated nominal dynamic power from the power estimators in the multiple PBUs to the global power accumulator.
(11) the additional dedicated wiring couples neighboring PBUs within a row of the array of PBUs in a daisy chain, and the reconfigurable processor IC further comprises a row power accumulator configured to determine a row total estimated dynamic power dissipation in a row of PBUs, and to transmit the row total estimated dynamic power dissipation in the row of PBUs to the global power accumulator via the additional dedicated wiring.
(12) the additional dedicated wiring couples neighboring PBUs within a column of the array of PBUs in a daisy chain, and the reconfigurable processor IC further comprises a column power accumulator configured to determine a column total estimated dynamic power dissipation in a column of PBUs, and to transmit the column total estimated dynamic power dissipation in the column of PBUs to the global power accumulator via the additional dedicated wiring.
(13) the reconfigurable processor IC further comprises a global control circuit coupled to the global power accumulator and configured to: determine whether the array-level nominal dynamic power estimate exceeds a first global threshold or whether the array-level nominal dynamic power estimate is below a second global threshold; in response to determining that the array-level nominal dynamic power estimate exceeds the first global threshold: generate a first global control signal, and transmit the first global control signal via the additional dedicated wiring to the multiple PBUs to initiate the first predetermined countermeasure, and in response to determining that the array-level nominal dynamic power estimate is below the second global threshold: generate a second global control signal, and transmit the second global control signal via the additional dedicated wiring to the multiple PBUs to initiate the second predetermined countermeasure.
(14) the first and second thresholds are selected based on a previously determined local nominal dynamic power estimate.
(15) the first threshold increases with the previously determined local nominal dynamic power estimate, and the second threshold decreases with the previously determined local nominal dynamic power estimate.

As another example, a reconfigurable processor IC comprises multiple power base units (PBUs) arranged in an array of rows and columns with dedicated wiring that couples neighboring PBUs of the multiple PBUs, and wherein a PBU of the multiple PBUs comprises a compute unit, and a method of operating the reconfigurable processor IC comprises: in a power estimator (PE) in the PBU, determining an estimated nominal dynamic power dissipated at least by the compute unit in the PBU; in a local power accumulator in the PBU, adding the estimated nominal dynamic power to an accumulated nominal dynamic power received from a neighboring PBU of the neighboring PBUs via the dedicated wiring to determine a local nominal dynamic power estimate; in a local control circuit in the PBU that is coupled to the local power accumulator of the PBU, determining whether the local nominal dynamic power estimate exceeds a first threshold or is below a second threshold; in response to determining that the local nominal dynamic power estimate exceeds the first threshold: generating a first control signal, and initiating a first predetermined countermeasure that affects a ramp-up current in the PBU, and in response to determining that the local nominal dynamic power estimate is below the second threshold: generating a second control signal, and initiating a second predetermined countermeasure that affects a ramp-down current in the PBU.

The foregoing example and other described implementations can each, optionally, include one or more of the following features:
(1) with the local control circuit, transmitting the first control signal or the second control signal via the dedicated wiring to the neighboring PBU.
(2) in a global power accumulator, determining an array-level nominal dynamic power estimate by determining a sum of the estimated nominal dynamic power from the multiple PBUs; and using additional dedicated wiring in the reconfigurable processor IC to transmit the estimated nominal dynamic power from the power estimators in the multiple PBUs to the global power accumulator.
(3) in a global control circuit coupled to the global power accumulator: determining whether the array-level nominal dynamic power estimate exceeds a first global threshold or whether the array-level nominal dynamic power estimate is below a second global threshold; in response to determining that the array-level nominal dynamic power estimate exceeds the first global threshold: generating a first global control signal, and transmitting the first global control signal via the additional dedicated wiring to the multiple PBUs to initiate the first predetermined countermeasure, and in response to determining that the array-level nominal dynamic power estimate is below the second global threshold: generating a second global control signal, and transmitting the second global control signal via the additional dedicated wiring to the multiple PBUs to initiate the second predetermined countermeasure.
(4) in a power clock management controller (PCMC) that is coupled with the global power accumulator via the additional dedicated wiring, determining a static power estimate based at least on a voltage and a temperature of the reconfigurable processor IC.

### Considerations

We describe various implementations of a power estimator, a power accumulator, and a control circuit for reducing the slopes of ramp-up and ramp-down currents in a CGR processor circuit.

The technology disclosed can be practiced as an apparatus, method, composition of matter, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections-these recitations are hereby incorporated forward by reference into each of the implementations described herein.

Although the description has been described with respect to specific implementations thereof, these specific implementations are merely illustrative, and not restrictive. The description may reference specific structural implementations and methods and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations on the description above.

As an example, the multiplexers 761 and 771 of FIG. 7 are shown between PBU 701 and 700 and between PBU 700 and 702. However, if desired, the multiplexers 761, 771 may be part of a PBU instead.

As another example, architecture 600 of FIG. 6 shows affecting a ramp-up or ramp-down current on a local level (e.g., within a local group consisting of PBU 611 and PBU 612) or on a global level (i.e., within every PBU 610 of architecture 600). If desired, architecture 600 may provide the additional ability of affecting a ramp-up or ramp-down current on a regional level, for example by providing regional power accumulators and regional control circuits for regions that include multiple columns of PBUs 610 (e.g., columns left of GPA 635 of FIG. 6 and columns right of GPA 635) but not all columns within the reconfigurable processor IC.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to specific implementations thereof, these specific implementations are merely illustrative, and not restrictive. For instance, many of the operations can be implemented on a printed circuit board (PCB) using off-the-shelf devices, in a System-on-Chip (SoC), application-specific integrated circuit (ASIC), programmable processor, a coarse-grained reconfigurable architecture (CGRA), or in a programmable logic device such as a field-programmable gate array (FPGA), obviating the need for at least part of any dedicated hardware. Implementations may be as a single chip, or as a multi-chip module (MCM) packaging multiple semiconductor dies in a single package. All such variations and modifications are to be considered within the ambit of the disclosed technology the nature of which is to be determined from the foregoing description.

Any suitable technology for manufacturing electronic devices can be used to implement the circuits of specific implementations, including CMOS, FinFET, GAAFET, BiCMOS, bipolar, JFET, MOS, NMOS, PMOS, HBT, MESFET, etc. Different semiconductor materials can be employed, such as silicon, germanium, SiGe, GaAs, InP, GaN, SiC, graphene, etc. Circuits may have single-ended or differential inputs, and single-ended or differential outputs. Terminals to circuits may function as inputs, outputs, both, or be in a high-impedance state, or they may function to receive supply power, a ground reference, a reference voltage, a reference current, or other. Although the physical processing of signals may be presented in a specific order, this order may be changed in different specific implementations. In some specific implementations, multiple elements, devices, or circuits shown as sequential in this specification can be operating in parallel.

One or more implementations of the technology or elements thereof can be implemented in the form of a computer product, including a non-transitory computer-readable storage medium with computer usable program code for performing any indicated method steps and/or any configuration file for one or more CGR processors to execute a high-level program. Furthermore, one or more implementations of the technology or elements thereof can be implemented in the form of an apparatus including a memory and at least one processor that is coupled to the memory and operative to perform exemplary method steps, and/or a CGR processor that is operative to execute a high-level program based on a configuration file. Yet further, in another aspect, one or more implementations of the technology or elements thereof can be implemented in the form of means for carrying out one or more of the method steps described herein and/or executing a high-level program described herein. Such means can include (i) hardware module(s); (ii) software module(s) executing on one or more hardware processors; (iii) bit files for configuration of a CGR array; or (iv) a combination of aforementioned items.

It will also be appreciated that one or more of the elements depicted in the drawings/figures can also be implemented in a more separated or integrated manner, or even removed or rendered as inoperable in certain cases, as is useful in accordance with a particular application.

Thus, while specific implementations have been described herein, latitudes of modification, various changes, and substitutions are intended in the foregoing disclosures, and it will be appreciated that in some instances some features of specific implementations will be employed without a corresponding use of other features without departing from the scope and spirit as set forth. Therefore, many modifications may be made to adapt a particular situation or material to the essential scope and spirit.

1. A reconfigurable processor integrated circuit (IC), comprising:
multiple power base units (PBUs) arranged in an array of rows and columns with dedicated wiring that couples neighboring PBUs of the multiple PBUs, wherein a PBU of the multiple PBUs comprises:
a compute unit;
a power estimator (PE) configured to determine an estimated nominal dynamic power dissipated at least by the compute unit in the PBU,
a local power accumulator that adds the estimated nominal dynamic power to an accumulated nominal dynamic power received from a neighboring PBU of the neighboring PBUs via the dedicated wiring to determine a local nominal dynamic power estimate, and
a local control circuit coupled to the local power accumulator and configured to:
generate a first control signal and initiate a first predetermined countermeasure that affects a ramp-up current in the PBU upon determining that the local nominal dynamic power estimate exceeds a first threshold, and
generate a second control signal and initiate a second predetermined countermeasure that affects a ramp-down current in the PBU upon determining that the local nominal dynamic power estimate is below a second threshold.

2. The reconfigurable processor IC of claim 1, wherein the power estimator is configured to determine the estimated nominal dynamic power based on monitoring input data bit toggling, instruction type, and processing activity of one or more reconfigurable data processing stages included in the compute unit.

3. The reconfigurable processor IC of claim 1, wherein the local control circuit is further configured to transmit the first control signal or the second control signal via the dedicated wiring to the neighboring PBU.

4. The reconfigurable processor IC of claim 2, wherein the neighboring PBU further comprises:
an additional local control circuit that receives the first control signal or the second control signal from the local control circuit via the dedicated wiring and that is configured to:
initiate the first predetermined countermeasure that affects a ramp-up current in the neighboring PBU upon receiving the first control signal, and
initiate the second predetermined countermeasure that affects a ramp-down current in the neighboring PBU upon receiving the second control signal.

5. The reconfigurable processor IC of claim 1, further comprising:
a first-in first-out (FIFO) buffer coupled to the compute unit, and wherein the first predetermined countermeasure comprises an insertion of a predetermined number of bubbles into the FIFO.

6. The reconfigurable processor IC of claim 4, wherein the second predetermined countermeasure comprises executing a predetermined number of dummy operations in the compute unit.

7. The reconfigurable processor IC of claim 1, wherein the dedicated wiring couples neighboring PBUs within a row of the array of PBUs in a daisy-chain.

8. The reconfigurable processor IC of claim 1, wherein the dedicated wiring couples neighboring PBUs within a column of the array of PBUs in a daisy-chain.

9. The reconfigurable IC of claim 1, wherein the dedicated wiring that couples the PBU with an additional neighboring PBU of the neighboring PBUs further comprises:
a multiplexer with a first input coupled to the PBU, a second input coupled to zero, an output coupled to the additional neighboring PBU, and a configurable selector input, wherein the configurable selector input is configured to couple the first input to the output when the PBU and the additional neighboring PBU are in a same local group with a common local ramp control, and wherein the configurable selector input is configured to couple the second input to the output when the PBU and the additional neighboring PBU are in separate local groups with a separate local ramp control.

10. The reconfigurable processor IC of claim 1, further comprising:
a global power accumulator (GPA) that is configured to determine an array-level nominal dynamic power estimate by determining a sum of the estimated nominal dynamic power from the multiple PBUs; and
additional dedicated wiring that transmits the estimated nominal dynamic power from the power estimators in the multiple PBUs to the global power accumulator.

11. The reconfigurable processor IC of claim 10, wherein the additional dedicated wiring couples neighboring PBUs within a row of the array of PBUs in a daisy chain, further comprising:
a row power accumulator configured to determine a row total estimated dynamic power dissipation in a row of PBUs, and to transmit the row total estimated dynamic power dissipation in the row of PBUs to the global power accumulator via the additional dedicated wiring.

12. The reconfigurable processor IC of claim 10, wherein the additional dedicated wiring couples neighboring PBUs within a column of the array of PBUs in a daisy chain, further comprising:
a column power accumulator configured to determine a column total estimated dynamic power dissipation in a column of PBUs, and to transmit the column total estimated dynamic power dissipation in the column of PBUs to the global power accumulator via the additional dedicated wiring.

13. The reconfigurable processor IC of claim 10, further comprising:
a global control circuit coupled to the global power accumulator and configured to:
determine whether the array-level nominal dynamic power estimate exceeds a first global threshold or whether the array-level nominal dynamic power estimate is below a second global threshold;
in response to determining that the array-level nominal dynamic power estimate exceeds the first global threshold:
generate a first global control signal, and
transmit the first global control signal via the additional dedicated wiring to the multiple PBUs to initiate the first predetermined countermeasure, and
in response to determining that the array-level nominal dynamic power estimate is below the second global threshold:
generate a second global control signal, and
transmit the second global control signal via the additional dedicated wiring to the multiple PBUs to initiate the second predetermined countermeasure.

14. The reconfigurable processor IC of claim 1, wherein the first and second thresholds are selected based on a previously determined local nominal dynamic power estimate.

15. The reconfigurable processor IC of claim 14, wherein the first threshold increases with the previously determined local nominal dynamic power estimate, and wherein the second threshold decreases with the previously determined local nominal dynamic power estimate.

16. A method of operating a reconfigurable processor IC having multiple power base units (PBUs) arranged in an array of rows and columns with dedicated wiring that couples neighboring PBUs of the multiple PBUs, and wherein a PBU of the multiple PBUs comprises a compute unit, comprising:
in a power estimator (PE) in the PBU, determining an estimated nominal dynamic power dissipated at least by the compute unit in the PBU;
in a local power accumulator in the PBU, adding the estimated nominal dynamic power to an accumulated nominal dynamic power received from a neighboring PBU of the neighboring PBUs via the dedicated wiring to determine a local nominal dynamic power estimate;
in a local control circuit in the PBU that is coupled to the local power accumulator of the PBU, determining whether the local nominal dynamic power estimate exceeds a first threshold or is below a second threshold;
in response to determining that the local nominal dynamic power estimate exceeds the first threshold:
generating a first control signal, and
initiating a first predetermined countermeasure that affects a ramp-up current in the PBU, and
in response to determining that the local nominal dynamic power estimate is below the second threshold:
generating a second control signal, and
initiating a second predetermined countermeasure that affects a ramp-down current in the PBU.

17. The method of claim 16, further comprising:
with the local control circuit, transmitting the first control signal or the second control signal via the dedicated wiring to the neighboring PBU.

18. The method of claim 16, further comprising:
in a global power accumulator, determining an array-level nominal dynamic power estimate by determining a sum of the estimated nominal dynamic power from the multiple PBUs; and
using additional dedicated wiring in the reconfigurable processor IC to transmit the estimated nominal dynamic power from the power estimators in the multiple PBUs to the global power accumulator.

19. The method of claim 18, further comprising:
in a global control circuit coupled to the global power accumulator:
determining whether the array-level nominal dynamic power estimate exceeds a first global threshold or whether the array-level nominal dynamic power estimate is below a second global threshold;
in response to determining that the array-level nominal dynamic power estimate exceeds the first global threshold:
generating a first global control signal, and
transmitting the first global control signal via the additional dedicated wiring to the multiple PBUs to initiate the first predetermined countermeasure, and
in response to determining that the array-level nominal dynamic power estimate is below the second global threshold:
generating a second global control signal, and
transmitting the second global control signal via the additional dedicated wiring to the multiple PBUs to initiate the second predetermined countermeasure.

20. The method of claim 18, further comprising:
in a power clock management controller (PCMC) that is coupled with the global power accumulator via the additional dedicated wiring, determining a static power estimate based at least on a voltage and a temperature of the reconfigurable processor IC.
